(19) United States
(12) Patent Application Publication
(10) Pub. No.: US 2026/0093318 A1
(43) Pub. Date: Apr. 2, 2026

(54) TAPPING ACTION RECOGNITION METHOD AND VEHICLE CONTROL DEVICE APPLIED TO VEHICLE

(71) Applicant: SHANGHAI TAIFANG TECHNOLOGY CO., LTD, Shanghai (CN)

(72) Inventors: Chaoliang DU, Shanghai (CN); Hongfeng GUO, Shanghai (CN)

(21) Appl. No.: 19/345,156

(22) Filed: Sep. 30, 2025

(30) Foreign Application Priority Data
Sep. 30, 2024 (CN) 2024113954806
Dec. 5, 2024 (CN) 2024117895760
May 16, 2025 (CN) 2025106379698
Sep. 15, 2025 (CN) 202511318891X

(51) Int. Cl. G06F 3/01; G01H 1/00; G06V 40/16

(52) U.S. Cl. CPC G06F 3/011; G01H 1/00; G06V 40/161

(57) ABSTRACT

A tapping action recognition method applied to a vehicle and a vehicle control apparatus, wherein the vehicle is provided with an elastic wave sensor, the method including: receiving elastic wave signals captured by the elastic wave sensor; based on at least the elastic wave signals, determining whether a preset quantity of tapping actions on the vehicle have occurred within a preset time period and the preset quantity of tapping actions are real tapping actions; responding to the tapping actions when determining that the real tapping actions on the vehicle have occurred.

### CROSS-REFERENCE TO RELATED APPLICATIONS

This application claims priority to Chinese patent application No. 2024113954806, filed on Sep. 30, 2024 and entitled “Touch Positioning Method and Device”, Chinese patent application No. 2024117895760, filed on Dec. 5, 2024 and entitled “Recognition Method for Continuous Touch Signal, Control Apparatus, and Storage Medium”, Chinese patent application No. 2025106379698, filed on May 16, 2025 and entitled “Tapping Signal Recognition Method, Storage Medium, Controller and Vehicle”, and Chinese patent application No. 202511318891X, filed on Sep. 15, 2025 and entitled “Tapping Action Recognition Method and Vehicle Control Device Applied to Vehicle”, the contents of the above-identified applications are hereby incorporated herein by reference.

### TECHNICAL FIELD

Embodiments of that present disclosure relate to, but are not limited to, touch technology for vehicle, in particular to a tapping action recognition method and a vehicle control apparatus applied to a vehicle.

### BACKGROUND

At present, opening methods of a vehicle's front trunk include: opening the front trunk by an electronic button in the vehicle, opening the front trunk by a manual pull lever in the vehicle, opening by a button on a key to the vehicle, opening the front trunk by kick induction, and opening the front trunk by a physical button outside the vehicle. Among them, opening the front trunk by the electronic button in the vehicle and opening the front trunk by the manual pull lever in the vehicle requires people to walk back and forth inside and outside the vehicle, which is inconvenient to operate. Both opening the front trunk by the button on the key to the vehicle and opening the front trunk by kick induction require people to carry the key to the vehicle. Opening the front trunk by the physical button outside the vehicle affects waterproof and dustproof performance of the vehicle.

### SUMMARY

The following is a summary of subject matter described in the present disclosure in detail. This summary is not intended to limit the scope of protection of claims.

An embodiment of the present disclosure provides a tapping action recognition method and a vehicle control apparatus applied to a vehicle.

An embodiment of the disclosure discloses a tapping action recognition method applied to a vehicle which is provided with an elastic wave sensor, the method including: receiving elastic wave signals captured by the elastic wave sensor; determining whether a preset quantity of tapping actions on the vehicle have occurred within a preset time period based on at least the elastic wave signals; determining whether the preset quantity of tapping actions are real tapping actions; responding to the tapping actions when it is determined that the real tapping actions on the vehicle have occurred.

An embodiment of the disclosure discloses a vehicle control device including: a storage module configured to store computer program instructions executable on a processor; a processing module configured to execute the computer program instructions to implement the tapping action recognition method applied to the vehicle as described in the embodiment of the present disclosure.

According to technical solutions described in embodiments of the present disclosure, the vehicle can accurately recognize the specified and real tapping actions, and reliable support is provided for the vehicle to respond to the specified and real tapping actions.

Other characteristics and advantages of the present disclosure will be set forth in the following specification, and will become apparent in part from the specification, or will be learned by practicing the present disclosure. Other advantages of the present disclosure may be realized and obtained by the solutions described in the specification and the accompanying drawings.

After drawings and detailed description are read and understood, other aspects may be understood.

### BRIEF DESCRIPTION OF THE DRAWINGS

The accompanying drawings are used for providing understanding of technical solutions of the present disclosure, and form a part of the specification, and are used for explaining the technical solutions of the present disclosure together with the embodiments of the present disclosure, but do not form limitations on the technical solutions of the present disclosure.

FIG. 1 is a flowchart of a tapping action recognition method applied to a vehicle according to an embodiment of the present disclosure.

FIG. 2 is a flowchart for determining whether a preset quantity of tapping actions on a vehicle have occurred within a preset time period based on elastic wave signals according to an embodiment of the present disclosure.

FIG. 3 is a schematic diagram of a type of a plurality of raw touch signals according to an embodiment of the present disclosure.

FIG. 4 is a schematic diagram of signals after short-term energy calculation is performed on the signals shown in FIG. 3 according to an embodiment of the present disclosure.

FIG. 5 is a schematic diagram of signals after combination smoothing processing is performed on the signals shown in FIG. 4 according to an embodiment of the present disclosure.

FIG. 6 is a layout schematic diagram of an elastic wave sensor according to an embodiment of the present disclosure.

FIG. 7 shows a schematic diagram of a correspondence relationship between a time difference between two different frequency component signals arriving at an elastic wave sensor and a known touch position according to an embodiment of the present disclosure.

FIG. 8 is a schematic diagram of a time domain elastic wave signal according to an embodiment of the present disclosure.

FIG. 9 is a schematic diagram of a frequency domain elastic wave signal according to an embodiment of the present disclosure.

FIG. 10 is a schematic diagram of a first frequency component signal and a second frequency component signal according to an embodiment of the present disclosure.

FIG. 11 is a schematic diagram of envelope signals of a first frequency component signal and a second frequency component signal according to an embodiment of the present disclosure.

FIG. 12 is a schematic diagram showing a time difference between peak points of two envelope signals according to an embodiment of the present disclosure.

FIG. 13 is a schematic diagram of a correspondence relationship between a slope determined based on two different frequency component signals and a known touch position according to an embodiment of the present disclosure.

FIG. 14 is a schematic diagram of another elastic wave signal and a wave head signal thereof according to an embodiment of the present disclosure.

FIG. 15 is an enlarged view of a wave head signal according to an embodiment of the present disclosure.

FIG. 16 is a schematic diagram showing absolute values of a wave head signal according to an embodiment of the present disclosure.

FIG. 17 is a schematic diagram of peak points according to an embodiment of the present disclosure.

FIG. 18 is a schematic diagram of a set of peak points with increasing values according to an embodiment of the present disclosure.

FIG. 19 is a schematic diagram of a fitting straight line according to an embodiment of the present disclosure.

FIG. 20 is a schematic diagram of training a machine learning model according to an embodiment of the present disclosure.

FIG. 21 is a module diagram of a vehicle control device according to an embodiment of the present disclosure.

FIG. 22 is a module diagram of a vehicle control apparatus according to an embodiment of the present disclosure.

### DETAILED DESCRIPTION

The present disclosure describes a plurality of embodiments, but the description is exemplary and not restrictive, and those skilled in the art will realize that more embodiments and implementations may be included within the scope of the embodiments described in the present disclosure. Although many possible combinations of features are shown in the drawings and discussed in the detailed description, many other combinations of the disclosed features are also possible. Unless specifically limited, any feature or element of any embodiment may be used in combination with any other feature or element of any other embodiment, or may be substituted for any other feature or element of any other embodiment.

The present disclosure includes and contemplates combinations with features and elements known to those skilled in the art. Embodiments, features, and elements already disclosed in the present disclosure may also be combined with any conventional features or elements to form unique inventive solutions. Any feature or element of any embodiment may also be combined with features or elements from other inventive solutions to form another unique inventive solution. Accordingly, it should be understood that any of the features of at least one of the shown and discussed embodiments in this disclosure may be implemented alone or in any suitable combination. Accordingly, except for the limitations imposed by the appended claims and their equivalents, the embodiments are not subject to other restrictions. Furthermore, various modifications and changes may be made within the scope of the appended claims.

Furthermore, in describing representative embodiments, the specification may have presented at least one of methods and processes as particular sequences of steps. However, to the extent that the at least one method or process does not depend on a particular sequence of steps described herein, the method or process should not be limited to the particular sequence of steps described. As will be understood by those skilled in the art, other sequence of steps is also possible. Accordingly, the particular sequence of steps set forth in the specification should not be construed as limitations on the claims. Furthermore, claims directed to at least one of the method and the process should not be limited to performing their steps in the sequence in which they are written, and those skilled in the art can easily understand that these sequences may vary and still remain within the essence and scope of the embodiments of the present disclosure.

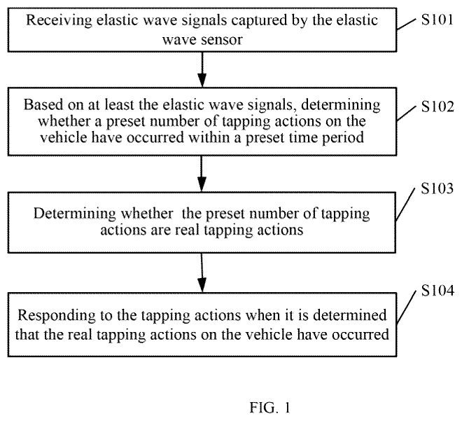

An embodiment of the present disclosure provides a tapping action recognition method applied to a vehicle, and the vehicle is provided with an elastic wave sensor, as shown in FIG. 1, the method includes:
Step S101: receiving an elastic wave signal captured by the elastic wave sensor;
Step S102: determining, at least based on the elastic wave signal, whether a preset quantity of tapping actions on the vehicle have occurred within a preset time period;
Step S103: determining the preset quantity of tapping actions are real tapping actions;
Step S104: responding to the tapping actions when it is determined that the real tapping actions on the vehicle have occurred.

According to the technical solutions described in the embodiments of the present disclosure, the vehicle can accurately recognize specified and real tapping actions, and reliable support is provided for the vehicle to respond to the specified and real tapping actions.

In an exemplary embodiment, the receiving the elastic wave signal captured by the clastic wave sensor includes:
receiving the elastic wave signal collected by the elastic wave sensor when the vehicle is in a sleep state or a wake-up state;
the tapping action recognition method applied to the vehicle further includes: comparing a signal strength of the elastic wave signal with a first threshold for triggering the vehicle to wake up when the vehicle is in the sleep state and waking up the vehicle when the signal strength of the elastic wave signal is greater than the first threshold; wherein the signal strength of the elastic wave signal may be expressed by a peak value, a peak-to-peak value, a root mean square value, or the like of the signal;
when the vehicle is in the wake-up state, further performing the operation of: determining, based on at least the elastic wave signal, whether the preset quantity of tapping actions on the vehicle have occurred within the preset time period and determining whether the preset quantity of tapping actions are the real tapping actions.

When the vehicle is in the wake-up state, it usually means that an electrical system of the vehicle switches from a “shutdown and power saving” state to a “standby” state some or all of ECUs, a bus, sensors, an entertainment system, or the like of the vehicle are powered on, and the vehicle can respond to keys, mobile phones, doors, cloud, touch and other triggers.

When the vehicle is in the sleep state, it usually means that the electrical system of the vehicle is in a “shutdown and power saving” mode, that is, an engine/motor is powered off, almost all ECUs are powered off, the bus is silent, and only a few modules are left to run at low power. In an embodiment of the present disclosure, the elastic wave sensor provided in the vehicle in the sleep state is in an operating state.

As an example, when the vehicle is in the sleep state, and when a user attempts to open a front (rear) trunk of the vehicle by a double-click gesture (also referred to as knock-knock gesture in embodiments of the present disclosure, abbreviated as a kk gesture), an elastic wave signal generated by the KK gesture tapping on the front (rear) trunk can be collected by the elastic wave sensor of the vehicle, and the vehicle can be woke up after it is determined that a signal strength of an elastic wave signal generated by the user tapping for a first time exceeds the first threshold for triggering the vehicle to wake up. When the vehicle is in the wake-up state, clastic wave signals generated by the KK gesture tapping the front (rear) trunk can be continuously received by the elastic wave sensor of the vehicle.

In an exemplary embodiment, based on at least the elastic wave signal, determining whether the preset quantity of the tapping actions on the vehicle have occurred within the preset time period includes:
Monitoring the elastic wave signals, buffering a segment of an elastic wave signal with a predetermined length when a signal strength of the elastic wave signal is greater than a second threshold for triggering signal collection, and the second threshold is greater than or equal to the first threshold. For example, the second threshold is greater than the first threshold. For example, the first threshold is 50 signal strength units, the second threshold is 100 signal strength units, and when a strength of the received elastic wave signal reaches the first threshold, the vehicle is woke up. When the vehicle is woke up, the strength of the received elastic wave signal at this time may have increased to 70 signal strength units, and selecting the second threshold to be greater than the first threshold can avoid data loss of the buffered elastic wave signal. The predetermined length of the buffered elastic wave signal may be determined based on a statistical duration of elastic wave signals generated by single tap actions.

When it is determined that the segment of elastic wave signal is an elastic wave signal generated by a single tapping action, recognizing the segment of the elastic wave signal as a single tapping signal and continuing to monitor the elastic wave signals. For example, whether the elastic wave signal is generated by a single tapping action may be recognized based on signal characteristics of the elastic wave signal, and the signal characteristics may include one or more of signal time domain characteristics (such as one or more of peak value, root mean square value, peak factor, waveform variation factor, mean filtering, median filtering, integration, and a quantity of peaks) and signal frequency domain characteristics (such as one or more of low frequency signal energy ratio, intermediate frequency signal energy ratio, and high frequency signal energy ratio);

When Num single tap signals are recognized within the preset time period, determining that the preset quantity of tapping actions on the vehicle have occurred within the preset time period, wherein Num is equal to the preset quantity, and Num is an integer greater than or equal to 1.

As an example, when the vehicle is in the sleep state a first tapping action is performed on the vehicle. The vehicle is woke up when a signal strength of an elastic wave signal generated by the first tapping action reaches a wake up threshold of the vehicle, and a segment of the elastic wave signal is buffered after the signal strength of the elastic wave signal continues to rise to a signal acquisition threshold. Then a second tapping action is performed on the vehicle, because the vehicle is already in the wake-up state, directly after an elastic wave signal generated by the second tapping action reaches the acquisition threshold, continuing to buffer a segment of the elastic wave signal. When a time interval between the two buffered elastic wave signals is within a preset time period T, and a double-click action for opening the front trunk of the vehicle occurs within the preset time period T, the front trunk is opened, that is, an effect of waking up the vehicle and also opening the front trunk by the double-click action is realized by the solution described in the embodiment of the present disclosure.

The “and continuing to monitor the elastic wave signals” described in the embodiment of the present disclosure occurs after the single tapping signal is recognized, at this time, a timing may not reach the preset time period, or the timing may have reached the preset time period but Num single tapping signals are not recognized, or Num single tapping signals may have been recognized within the preset time period (the elastic wave signals may continue to be monitored thereafter). Further, the preset time period may have a start time of the first single tapping signal as the start time, have an end time of the first single tapping signal as the start time, or have a time at which the first single tapping signal is recognized as the start time.

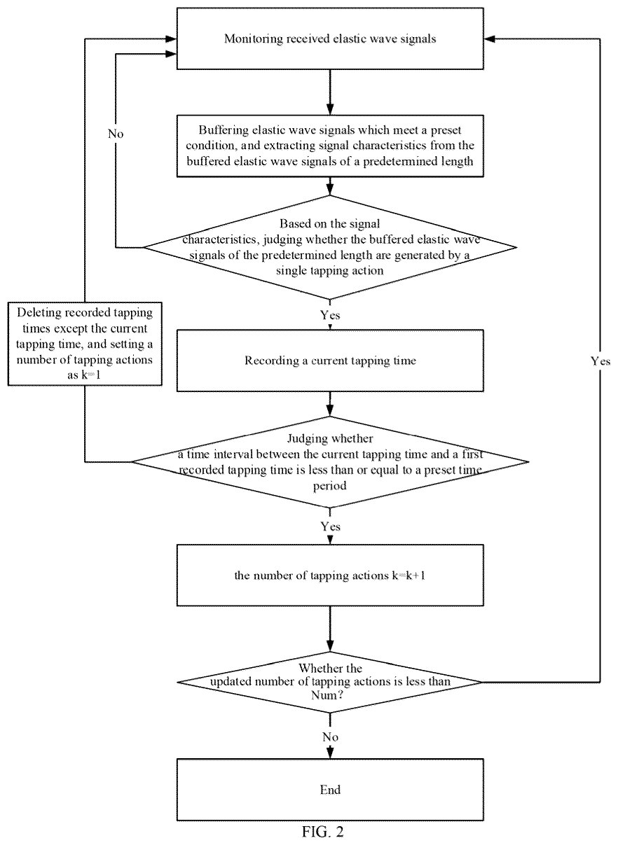

FIG. 2 shows an example diagram of determining whether a preset quantity of tapping actions on a vehicle has occurred within a preset time period based on elastic wave signals. As shown in FIG. 2, it includes: monitoring received elastic wave signals, buffering a segment of an elastic wave signal of a predetermined length after a signal strength of a received clastic wave signal reaches a second threshold, and judging whether the segment of elastic wave signal is a single tapping signal based on signal characteristics of the segment of the elastic wave signal;
when the segment of elastic wave signal is a single tapping signal, recording a current tapping time (a start time of this segment of elastic wave signals can be taken as the current tapping time), and judging whether a time interval between the current tapping time and a first recorded tapping time is less than or equal to the preset time period; when the segment of clastic wave signal is not a single tapping signal, returning and continuing to monitor the received elastic wave signals;
when the time interval between the current tapping time and the first recorded tapping time is less than or equal to the preset time period, increasing a quantity of tapping actions by 1, with an initial value of the quantity of tapping actions being 0, and then continuing to judge whether an updated quantity of tapping actions is less than the preset quantity Num; when the time interval between the current tapping time and the recorded first tapping time is greater than the preset time period, deleting the recorded tapping time except the current tapping time, and setting the quantity of tapping actions to 1, returning and continuing to monitor the received elastic wave signals, that is, starting from the current tapping time, re-judging whether there are Num tapping actions within the preset time period;
when the updated quantity of tapping actions is less than the preset quantity Num, returning and continuing to monitor the received elastic wave signals until the updated quantity of tapping actions is equal to the preset quantity Num.

In an exemplary embodiment, the tapping action recognition method applied to the vehicle includes: determining whether the preset quantity of tapping actions on the vehicle are occurred within the preset time period based on elastic wave signals, and determining whether the preset quantity of tapping actions are real tapping actions based on the elastic wave signals; determining whether the preset quantity of tapping actions are the real tapping actions based on the clastic wave signals includes: determining the preset quantity of tapping actions are the real tapping actions when a matching degree between waveforms of the elastic wave signals generated by the preset quantity of tapping actions are greater than a preset first matching degree threshold. For example, signal characteristics of Num single tapping signals may be calculated for correlation analysis, and when Num≥2, a matching degree between waveforms of the Num single tapping signals may be obtained.

Since elastic wave signals generated by a plurality of continuous tapping actions (continuous means that adjacent tapping time intervals are less than a preset time period) show repeatable, mutually comparable and mutually verifiable statistical or physical connections on at least one characteristic of waveform, amplitude, frequency spectrum and arrival time, based on these connections, the embodiment of the present disclosure can effectively distinguish the plurality of continuous tapping actions from random noise, a plurality of independent tapping actions or other interference events by calculating the matching degrees between the elastic wave signals generated by the preset quantity of tapping actions, and improve a recognition accuracy.

The tapping action recognition method described in the embodiment of the present disclosure is suitable for tapping the vehicle by objects made of different materials (such as fingers, mobile phones, gloves), has high universality, and supports user-defined tapping methods (for example, double-click or triple-click within 500 milliseconds, or double-click within 500 milliseconds and triple-click within 1 second may be set), thereby improving user experience.

In an exemplary embodiment, the tapping action recognition method applied to the vehicle further includes: determining environmental information using detection signals from vehicle sensors when monitoring the elastic wave signals, and the environmental information includes at least one of:
ambient noise value;
information for judging an operating temperature of the elastic wave sensor;
performing at least one of the following operations based on the environmental information:
adjusting the second threshold based on the ambient noise value since the ambient noise affects recognition of the elastic wave signals, wherein adjusting the second threshold based on the ambient noise can improve the recognition accuracy of the elastic wave signals;
when it is judged that the operating temperature of the elastic wave sensor exceeds a preset temperature threshold based on the information for judging the operating temperature of the elastic wave sensor, performing signal amplification on current buffered segment of elastic wave signals, thereby performing subsequent operations based on the buffered elastic wave signals. Considering that an elastic wave signal will attenuate with increasing temperature, when the operating temperature of the elastic wave sensor exceeds the preset temperature threshold, amplifying the buffered segment of elastic wave signal can reduce noise interference, improve a signal-to-noise ratio of the elastic wave signal, which is conducive to improving the recognition accuracy.

In an exemplary embodiment, the vehicle sensors includes: at least one of a precipitation sensor, a vibration sensor, and a temperature sensor.

Determining the ambient noise value using the detection signal from the vehicle sensor includes at least one of the following:
determining the ambient noise value based on a detection signal of the precipitation sensor; common precipitation sensors include an optical precipitation sensor and an acoustic signal-based precipitation sensor;
determining the ambient noise value based on a detection signal from the vibration sensor; wherein on the one hand, it is considered that the precipitation sensor may fail in case of damage, obstructed, hail, or the like, and on the other hand, in order to obtain ambient noise in non-rainy weather, it may be considered that the ambient noise value is determined using the vibration sensor, and the vibration sensor may be an acceleration sensor, a piezoelectric sensor, a piezoresistive sensor, a capacitive sensor, a servo sensor, or an elastic wave sensor;
determining the ambient noise value based on a detection signal from the precipitation sensor and a detection signal from the vibration sensor.

In an exemplary embodiment, determining the ambient noise value based on the detection signal from the precipitation sensor and the detection signal from the vibration sensor includes:
determining a rain calibration value based on the detection signal from the precipitation sensor; wherein rain may include light rain, moderate rain, heavy rain, rainstorm and other corresponding rain; with increasing rain, the ambient noise generated will also increase; for example, the rain calibration value is represented by Drain, and its value is [0, 1, 2, 3, 4, 5], corresponding to no rain, light rain, moderate rain, heavy rain, rainstorm and a grade above rainstorm;
determining a vibration noise calibration value based on the detection signal from the vibration sensor; wherein the rain calibration value and the vibration noise calibration value are both values greater than or equal to 0;
performing a weighted summation on the rain calibration value and the vibration noise calibration value to obtain the ambient noise value.

In an exemplary embodiment, determining the vibration noise calibration value based on the detection signal from the vibration sensor includes the following periodic processing:
respectively determining background noise signal characteristic values of the vibration sensor within a plurality of second windows, wherein the plurality of second windows form a first window; for example, a background noise signal characteristic value may be a combination of one or more of a peak-to-peak value, a variance value, a standard deviation value, a peak-to-mean ratio, a peak factor, and a pulse factor of the background noise signal;
determining vibration noise calibration values corresponding to the plurality of second windows based on vibration noise intervals in which the background noise signal characteristic values in the plurality of second windows fall; for example, a vibration noise calibration value is represented by S_{elastic}, which is [0, 1, 2, 3, 4, 5], corresponding to no noise, mild noise, moderate noise, sub-severe noise, severe noise and super-severe noise; a relationship between a background noise signal characteristic value and a vibration noise calibration value is shown as the following formula:

$${S}_{elastic} = \{ \begin{matrix}0 & A \leq a \\ 1 & a < A \leq b \\ 2 & b < A \leq c \\ 3 & b < A \leq d \\ 4 & d < A \leq e \\ 5 & A < e\end{matrix} ,$$

where A represents the background noise signal characteristic value;
when more than a set quantity of second windows in the plurality of second windows corresponds to a same vibration noise calibration value, determining this vibration noise calibration value as a vibration noise calibration value corresponding to the first window;
wherein a movement step size of the first window is equal to a window length of the second windows.

For example, if the first window is about 12 s and the second window is about 500 ms, there are about 24 second windows in the first window. Here, “about” as used herein refers to a numerical value that does not strictly define a boundary and allow for process and measurement errors. The background noise signal characteristic values in the 24 second windows are judged, and then: when background noise signal characteristic values in 20 second windows are less than or equal to a threshold a during 12 seconds, it is considered that the first window corresponds to no noise, and the vibration noise calibration value is 0; when background noise signal characteristic values in 20 second windows are greater than the threshold a and less than or equal to a threshold b during 12 s, it is considered that the first window corresponds to mild noise, and the vibration noise calibration value is 1; when background noise signal characteristic values in 20 second windows are greater than the threshold b and less than or equal to a threshold c during 12 s, it is considered that the first window corresponds to moderate noise, and the vibration noise calibration value is 2; when background noise signal characteristic values in 20 second windows are greater than the threshold c and less than or equal to a threshold d during 12 s, it is considered that the first window corresponds to the sub-severe noise, and the vibration noise calibration value is 3; when background noise signal characteristic values in 20 second windows are greater than the threshold d and less than or equal to a threshold e within 12 s, it is considered that the first window corresponds to the severe noise, and the vibration noise calibration value is 4; when background noise characteristic values in 20 second windows are greater than e during 12 s, it is considered that the first window corresponds to the super-heavy noise, and the vibration noise calibration value is 5.

The method of determining the vibration noise calibration value based on the detection signal from the vibration sensor described in the embodiment of the present disclosure may also be applied for determining the rain calibration value based on the detection signal from the precipitation sensor.

In an exemplary embodiment, performing the weighted summation on the rain calibration value and the vibration noise calibration value to obtain the ambient noise value includes at least one of the following:
when the rain calibration value and the vibration noise calibration value are both greater than 0, the ambient noise value is jointly determined by the rain calibration value and the vibration noise calibration value, that is, weights for the rain calibration value and the vibration noise calibration value are both greater than 0; this case can correspond to environments in which: it rains, the precipitation sensor is faultless and unobstructed, and the vibration sensor is faultless and unobstructed; for example, Info=ω₁*Sᵣₐᵢₙ+ω₂*S_{elastic}, where ω₁, ω₂ are weight coefficients, ω₁+ω₂=1 Info is an ambient noise value, Sᵣₐᵢₙ represents the rain calibration value, and S_{elastic} represents the vibration noise calibration value;
when the rain calibration value is 0, the ambient noise value is determined only by the vibration noise calibration value, that is, a weight for the rain calibration value is 0, and a weight for the vibration noise calibration value is 1; this case can correspond to environments in which: the precipitation sensor cannot be used due to factors such as hail, or in non-rainy environments;
when the vibration noise calibration value is 0, the ambient noise value is determined only by the vibration noise calibration value, that is, the weight for the rain calibration value is 0, and the weight for the vibration noise calibration value is 1; or, when the vibration noise calibration value is 0, the ambient noise value is determined only by the rain calibration value, that is, the weight for the vibration noise calibration value is 0, and the weight for the rain calibration value is 1; this case can correspond to environments of: a local rain/car washing environment, in which an impact of rain on the vehicle only affects the precipitation sensor but not the vibration sensor. In these environments, the ambient noise may still be determined by the vibration sensor, or the ambient noise may be determined by the precipitation sensor.

In an exemplary embodiment, the adjusting the second threshold based on the ambient noise value includes:
when it is judged that the ambient noise value has increased, increasing the second threshold;
when it is determined that the ambient noise value has decreased, reducing the second threshold.

For example,

$$st\_thr = \{ \begin{matrix}50 & info \leq 2 \\ 100 & 2 < info \leq 3 \\ 150 & 3 < info \leq 4 \\ 200 & info > 4\end{matrix}$$

where, Info is the ambient noise value, st_thr is the second threshold, and a second threshold corresponding to an ambient noise value in each range can be set.

In the solution described in the embodiment of the present disclosure, the ambient noise value and the second threshold satisfy a trend that the larger the ambient noise value, the larger the second threshold, the smaller the ambient noise value, the smaller the second threshold, thereby suppressing an interference of the ambient noise on the recognition of the tapping actions, and reducing a probability of erroneous recognition of the tapping actions.

In an exemplary embodiment, the tapping action recognition method applied to the vehicle further includes:
after adjusting the second threshold based on the ambient noise value, determining an enabling state of the tapping action recognition based on the ambient noise value; the enabling state includes: enabling or de-enabling; the enabling represents that operations of the tapping action recognition are executable; the de-enabling represents that operations of the tap action recognition are not executable;
if the enabling state of the tapping action recognition is the enabling, performing subsequent operations when the signal strength of the elastic wave signal is greater than the second threshold;
if the enabling state of the tapping action recognition is the de-enabling, stopping the tapping action recognition, and then switching the enabling state of the tapping action recognition to the enabling when a preset condition is satisfied.

According to the method described in the embodiment of the present disclosure, it is possible to enable or de-enable the tapping action recognition based on the ambient noise, to suppress the interference of the ambient noise on the tapping action recognition, and to reduce the probability of erroneous recognition of the tapping actions.

In an exemplary embodiment, determining the enabling state of the tapping action recognition based on the ambient noise value includes:
if the ambient noise value is greater than or equal to a preset ambient noise threshold, determining the enabling state of the tapping action recognition as the de-enabling, and continuing for a preset de-enabled time period; if the ambient noise value is less than the preset ambient noise threshold, determining the enabling state of the tapping action recognition as the enabling; for example, when an info value or an info average value>=3 during 12 s, shielding a tapping signal recognition logic for about 10 s;
switching the enabling state of the tapping action recognition to the enabling when the preset condition is satisfied including:
when a preset de-enabling time period expires, switching the enabling state of the tapping action recognition to the enabling.

The embodiment of the present disclosure can temporarily shield the tapping action recognition function when the ambient noise is excessively large, thereby ensuring the accuracy of tapping action recognition, and avoiding dangers caused by turning on the tapping action recognition function.

In an exemplary embodiment, the tapping action recognition method applied to the vehicle further includes: before determining the environmental information by using the detection signals of the vehicle sensors, determining the environmental information by reusing the detection signals from the vehicle sensors when it is judged that a current state of the vehicle satisfies at least one of a preset first vehicle state and a preset second vehicle state.

Herein, the first vehicle state includes at least one of the vehicle being in an unlocked state and the vehicle key being within a preset region; for example, the preset region may be within a circle centered on the vehicle center and having a radius of a predetermined length; considering that when the vehicle is in a locked state or the vehicle key is far away from the vehicle, it is recognized that the tapping may be a potential safety hazard, for example, a tapping action may be performed by a someone except the owner himself, so the embodiment of the present disclosure can improve the safety of recognizing the tapping action on the vehicle by limiting the first vehicle state.

The second vehicle state includes at least one of a vehicle speed being less than or equal to a preset vehicle speed threshold and a gear position being in a P gear. Considering that when the vehicle is traveling at high speed, on the one hand, the owner of the vehicle does not tap an outer surface of the vehicle, and on the other hand, it is recognized that a tapping signal may be a potential safety hazard, for example, opening the hood will affect driving safety when the vehicle is traveling at high speed, so the embodiment of the present disclosure can also improve the safety of the vehicle tap action recognition by limiting the second vehicle state.

In an exemplary embodiment, the tapping action recognition method applied to the vehicle further includes:
acquiring perception information within a target time and a target space in which the tapping actions occur.

The tapping action recognition method applied to the vehicle according to the present embodiment includes: based on the elastic wave signals, determining whether the preset quantity of tapping actions on the vehicle have occurred within the preset time period, and based on the elastic wave signals and the perception information, or based on the perception information, determining whether the preset quantity of tapping actions are the real tapping actions.

In an embodiment of the present disclosure, the target time may be determined based on at least one of a start time and an end time of a single tapping signal. The target space can be determined based on an installation position of the elastic wave sensor from which the single tapping signal comes or a tapping position determined based on the elastic wave signals. Or when the tapping action recognition method applied to the vehicle recognizes tapping actions occurring in a specified region, the target space may be directly a region including the specified region (for example, when the tapping action recognition method applied to the vehicle recognizes the tapping actions on the vehicle front trunk, the target space may be the vehicle's front trunk and its surrounding regions).

The embodiment of the present disclosure recognizes authenticity of the tapping action in combination with the perception information, and can improve robustness (enhancement of anti-interference and anti-deception capabilities) and recognition accuracy of the tapping action recognition method applied to the vehicle in a complex environment.

In an exemplary embodiment, based on the elastic wave signals and the perception information, determining whether the preset quantity of tapping actions are the real tapping actions includes determining whether the preset quantity of tapping actions are the real tapping actions based on the perception information when the matching degrees between the waveforms of the elastic wave signals generated by the preset quantity of tapping actions are greater than a preset second matching degree threshold, wherein the second matching degree threshold is less than or equal to the first matching degree threshold.

In an exemplary embodiment, based on the perception information, determining whether the preset quantity of tapping actions are the real tapping action includes any one of the following:
the perception information includes information on whether a human body is detected, and based on the perception information, determining whether a human body is detected within the target time and the target space: when the human body is detected, determining that the preset quantity of tapping actions are the real tapping actions; when the human body is not detected, determining that the preset quantity of tapping actions are not the real tapping actions; wherein the information about the human body can be obtained from other sensors (such as a camera, a millimeter wave radar, a laser radar, a thermal imager, etc.) other than clastic wave sensor, for example, the camera can recognize the “human body” based on head and shoulder contours and key points of limbs, the millimeter wave radar can recognize the “human body” by using “gait micro-doppler” characteristics of a walker, the laser radar can recognize the “human body” by using a high-precision contour and a reflection intensity, and the thermal imager can recognize the “human body” by using a body temperature of the human body; the information about the human body may be only an indication information indicating a presence or absence of the human body, or imaging information on the “human body”;
the perception information includes portrait information, and the portrait information includes dynamic posture characteristics of the human body; determining whether there is timing synchronization between the dynamic posture characteristics and the tapping actions: when there is timing synchronization between the dynamic posture characteristics and the tapping actions, determining that the preset quantity of tapping actions are the real tapping actions; when there is no timing synchronization between the dynamic posture characteristics and the tapping actions, determining that the preset quantity of tapping actions are not the real tapping actions. The timing synchronization means that intervals between tapping times determined based on the action posture characteristics and start times of the elastic wave signals generated by the tapping actions are within a preset time range. For example, a method of determining a tapping time based on the action posture characteristics includes: taking a time at which an action of touching the vehicle is captured as the tapping time; or, taking a time at which an instantaneous speed of a downward arm is captured to plunge to a trough value as the tapping time. The action posture characteristics may be obtained from a result of radar detection, or maybe obtained from videos/images taken by the camera;
the perception information includes portrait information including static facial characteristics of the human body; determining whether the static facial characteristics are static facial characteristics of a legitimate user: when the static facial characteristics are the static facial characteristics of the legitimate user, determining that the preset quantity of tapping actions are the real tapping actions; when the static facial characteristics are not the static facial characteristics of the legitimate user, determining that the preset quantity of tapping actions are not the real tapping actions; wherein the static facial characteristics of the human body can be obtained from the videos/images taken by the camera, and the static facial characteristics of the legitimate user need to be stored into a vehicle storage module in advance; when determining the real tapping actions, verifying legitimacy of the user's identity from a perspective of facial characteristics can improve the anti-interference, anti-deception capabilities and recognition accuracy of the tapping action recognition method applied to the vehicle in a complex environment;
the perception information includes sound information; the sound information includes tapping sound information; determining whether there is timing synchronization between the tapping sound information and the tapping actions includes: when there is timing synchronization between the tapping sound information and the tapping actions, determining that the preset quantity of tapping actions are the real tapping actions; when there is no timing synchronization between the tapping sound information and the tapping actions, determining that the preset quantity of tapping actions are not the real tapping actions. The tapping sound information can be obtained from the videos captured by the camera; the timing synchronization between the tapping sound information and the tapping action means that intervals between start times of the tapping sounds and the start times of the elastic wave signals generated by the tapping actions are within a preset time range.

In another exemplary embodiment, the tapping action recognition method applied to the vehicle further includes: acquiring perception information within a target time and a target space at which the tapping actions occur, wherein the perception information includes at least one of portrait information and sound information. The portrait information includes: at least one of dynamic posture characteristics of a human body and static facial characteristics of the human body. The sound information includes tapping sound information.

The tapping action recognition method applied to the vehicle includes: based on both of the elastic wave signals and the perception information, determining whether the preset quantity of tapping actions on the vehicle have occurred within a preset time period and the preset quantity of tapping actions are the real tapping actions, and includes:
performing timestamp alignment and spatial calibration on the perception information and the single tapping signal to obtain synchronization data including at least one of a time domain characteristic and a frequency domain characteristic of the single tapping signal, and at least one of portrait characteristics acquired from the portrait information and sound characteristics acquired from the sound information; wherein a time domain characteristic of a tapping signal may include one or more of a peak value, a root mean square value, a peak factor, a waveform variation factor, a mean value filtering, a median value filtering, an integration, and a quantity of peaks; a frequency domain characteristic of a tapping signal may include one or more of a low-frequency signal energy ratio, an intermediate-frequency signal energy ratio, a high-frequency signal energy ratio, a difference calculation, and the quantity of peaks; the portrait characteristics include at least one of static facial characteristics and dynamic posture characteristics;
inputting the synchronization data into a trained neural network model, and based on an output of the neural network, determining whether the preset quantity of tapping actions on the vehicle have occurred within the preset time period and the preset quantity of tapping actions are the real tapping actions.

For example, the timestamp alignment of the perception information and the single tapping signal may be that the perception information for a corresponding time period is extracted from a video/radar detection result based on a duration of the single tapping signal. The spatial calibration of the perception information and the single tapping signal may be that the perception information for a corresponding position/region is extracted from the video/radar detection result based on the installation position of the elastic wave sensor from which the single tapping signal comes, the tapping position determined based on the elastic wave signal, or the specified region to which the tapping action recognition method of the vehicle is applied.

For example, the neural network model may include a modal attention network that maps the synchronization data to a same characteristic space through a fully connected layer and then performs weighted fusion. The fusion may adopt a decision tree model, and the decision tree model realizes the fusion through the following steps: aiming at a preset recognition accuracy rate, selecting an optimal split characteristic (such as a portrait facial characteristic, an arm action characteristic, a signal time domain characteristic, and a signal frequency domain characteristic) through an information gain criterion to construct a decision tree, and outputting a fusion decision result.

The embodiment of the present disclosure uses a neural network to perform the tapping action recognition, and although computing power may be increased, the recognition accuracy is greatly improved.

In an exemplary embodiment, the perception information may further include environmental information including at least one of rain information, ambient temperature, and ambient noise.

The tapping action recognition method applied to the vehicle further includes: before inputting the synchronous data into the trained neural network model, dynamically adjusting a weight proportion of each characteristic in the synchronous data based on the environment information. For example, when a visibility of the environmental information is poor, a weight of the elastic wave signal in the synchronization data is increased; when the environmental visibility is good, a weight of perception information is increased; when the ambient noise is large, the weight of the perception information is increased, because the noise may cause interference vibration on a vehicle surface which affects the elastic wave signal. The neural network synthesizes weight proportions of different characteristics and outputs a synthetic result.

By adding the environmental information, the embodiment of the present disclosure can improve an adaptability of the algorithm to various environments and improve a generalization performance of the algorithm.

In an exemplary embodiment, the tapping action recognition method applied to the vehicle includes: based on the elastic wave signals, determining whether the preset quantity of tapping actions on the vehicle have occurred within the preset time period and the preset quantity of tapping actions are the real tapping actions, which includes:
performing signal waveform morphological characteristic analysis and signal cross-correlation characteristic analysis on the plurality of elastic wave signals acquired within the preset time period when the preset quantity is multiple;
when it is analyzed that the signal waveform morphological characteristics and the signal cross-correlation characteristics are both consistent with signal characteristics corresponding to continuous tapping actions, determining that the preset quantity of real tapping actions on the vehicle have occurred within the preset time period.

The signal waveform morphological characteristics can reflect basic attributes and internal laws of the signals, and the signal cross-correlation characteristics can reflect similarity between different signals. The technical solution described in this disclosed embodiment considers continuous elastic wave signals from two aspects: the waveform morphology characteristics of the elastic wave signals and the cross-correlation characteristics between the elastic wave signals, expanding dimensions of consideration and improving the recognition accuracy of real tapping actions.

In an exemplary embodiment, the tapping action recognition method applied to the vehicle further includes:
after receiving a plurality of elastic wave signals captured by the elastic wave sensor, before performing the signal waveform morphological characteristic analysis and the signal cross-correlation characteristic analysis on the plurality of elastic wave signals, calculating a characteristic value of the plurality of elastic wave signals by taking the plurality of elastic wave signals as a whole signal first; and when the characteristic value is greater than a preset characteristic threshold, performing a step of performing the signal waveform morphological characteristic analysis and the signal cross-correlation characteristic analysis on the plurality of elastic wave signals. When the characteristic value is less than the preset characteristic threshold, it can be directly determined that the tapping is an ineffective tapping.

The characteristic value includes at least one of a peak-to-peak value and a root mean square value. The characteristic value being greater than the preset characteristic threshold includes at least one of the peak-to-peak value being greater than a corresponding preset threshold and the root mean square value being greater than a corresponding preset threshold.

In the embodiment of the present disclosure, sizes of the characteristic values of the elastic wave signals are initially screened, which can quickly eliminate ineffective tapping signals, reduce workload of subsequent characteristic analysis, and reduce unnecessary data processing costs.

In an exemplary embodiment, the plurality of elastic wave signals include a plurality of raw elastic wave signals captured by the elastic wave sensor or a preprocessed signals obtained by preprocessing the plurality of raw elastic wave signals. A pass band of the elastic wave sensor may be about 0 Hz to 2 kHz, and an interaction surface between a sensitive element of the sensor and a tapping action is arranged horizontally or nearly horizontally as much as possible.

In an example embodiment, preprocessing the plurality of raw elastic wave signals includes:
performing short-term energy value calculation on the plurality of raw elastic wave signals, for example, segmenting the plurality of raw elastic wave signals by framing or windowing, and calculating an energy value in each segment to obtain short-term energy values of the plurality of raw elastic wave signals; correspondingly, the preprocessed signals are short-term energy value signals of the plurality of raw elastic wave signals.

For example, the raw elastic wave signals are windowed, and a window length of each window is N, then a short-term energy value Eₙ in an n-th window is calculated by:

$${E}_{n} = {\sum }_{m = 0}^{N - 1} {x}_{n}^{2} ( m ) ,$$

where, xₙ(m) is a value of a raw elastic wave signal in the n-th window at an m-th sampling point.

Assuming that a data frame length of the plurality of raw elastic wave signals collected by the sensor is about 1000, that is, there are about 1000 sampled signals, and assuming that a window length N of each window is about 25 and a sliding step length of the window is about 5, a quantity of windows is about 196, a sum of squares of the 1^{st} to the 25^{th} sampled signals is E₁, and a sum of squares of the 6th to the 30th sampled signals is E₂, and so on, until E₁₉₆ is calculated.

The raw elastic wave signals are often non-stationary, and performing the short-term energy value calculation on the raw elastic wave signals can adapt to time-varying characteristics of the raw elastic wave signals, to detect changes of the raw elastic wave signals more sensitively and better analyze the characteristics of the raw elastic wave signals. The short-term energy value signals can also suppress background noise of the raw elastic wave signals and improve a signal-to-noise ratio of the signals. In the embodiment of the present disclosure, calculating the short-term energy value signals of the plurality of raw elastic wave signals is helpful for subsequently performing signal waveform morphological characteristic analysis and signal cross-correlation characteristic analysis, and improves the accuracy of characteristic analysis results.

In another exemplary embodiment, preprocessing the plurality of raw elastic wave signals includes:
calculating the short-term energy value signals of the plurality of raw elastic wave signals, and performing a combination smoothing processing on the short-term energy value signals, wherein the combination smoothing processing includes a plurality of single smoothing processing operations. Correspondingly, a preprocessed signal is a combined and smoothed signal.

According to the technical solution described in the embodiment of the present disclosure, after the short-term energy values of the plurality of raw elastic wave signals are calculated, performing the combination smoothing processing on the plurality of raw elastic wave signals can improve the quality of the signals, reduce or eliminate noise and unnecessary fluctuations, which facilitates performing the characteristic analysis of the elastic wave signals more accurately.

In an exemplary embodiment, the combination smoothing processing includes:
sequentially performing an N-point mean value smoothing processing, an M-point mean value smoothing processing, and a reverse K-point median value smoothing processing in a preset order, where N, M, and K are all positive integers, and N, M, and K may be the same or different. For example, a 3-point mean smoothing processing, a 6-point mean smoothing processing, and a reverse 5-point median smoothing processing are sequentially performed.

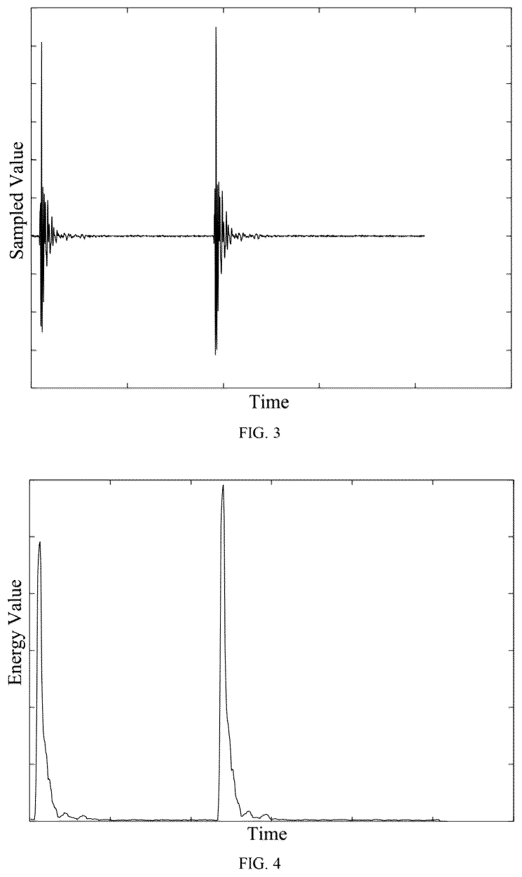

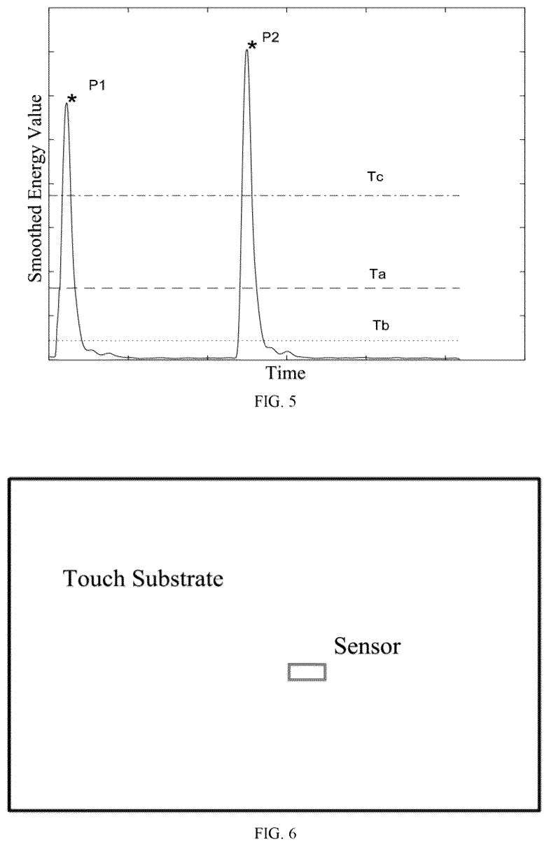

FIG. 3 is a schematic diagram of a plurality of raw elastic wave signals, and FIG. 4 is a schematic diagram of signals obtained by calculating the short-term energy values of the raw elastic wave signals shown in FIG. 3. FIG. 5 is a schematic diagram of signals after a combination smoothing processing is performed on the signals shown in FIG. 4. It can be seen from FIGS. 3 to 5 that the short-term energy value signals shown in FIG. 4 are smoother than the raw elastic wave signals shown in FIG. 3, and the smoothed signals shown in FIG. 5 has less signal glitch than the short-term energy value signals shown in FIG. 4.

In an exemplary embodiment, performing the signal waveform morphological characteristic analysis on the plurality of elastic wave signals includes one or more of the following ways:
way 1: performing double endpoint verification on each of the elastic wave signals;
way 2, for the plurality of elastic wave signals, analyzing a total quantity of peak points whose values are greater than a preset baseline Ta, and analyzing a duration T1 for each elastic wave signal is greater than or equal to the baseline Ta; for example, the preset baseline Ta is: Ta=e*(NIS+f), where NIS is a maximum value of noise portions of the plurality of elastic wave signals, e and f are hyperparameters;
way 3: analyzing a duration T2 for which each elastic wave signal is greater than or equal to a preset baseline Tc, wherein the preset baseline Tc is greater than the preset baseline Ta; for example, the preset baseline Tc is: Tc=Ta+(P−Ta)/2, where P is a peak value of each elastic wave signal;
way 4: for the plurality of elastic wave signals, analyzing a total duration T3 for which values are greater than a preset baseline Tb, and the preset baseline Tb is determined based on an average value of the plurality of elastic wave signals; a schematic diagram of a relationship between Tc, Ta and Tb is shown in the graph shown in FIG. 5;
way 5: analyzing a magnitude relation between the duration T1, the duration T2, and the total duration T3;
way 6: analyzing a time difference between peak points of two adjacent elastic wave signals;
way 7: analyzing a frequency corresponding to a median spectrum energy of each elastic wave signal;
way 8: analyzing a sum of all frequency energies less than or equal to a preset frequency threshold F of the plurality of elastic wave signals, where 0 Hz<F≤25 Hz;
way 9: analyzing all energy mean ratios of the plurality of elastic wave signals in a plurality of preset frequency bands, wherein the plurality of preset frequency bands include: [190 Hz, 1200 Hz], [1600 Hz, 2000 Hz].

In an exemplary embodiment, based on the ways of performing the signal waveform morphological characteristic analysis on the plurality of elastic wave signals, the signal waveform morphological characteristics being consistent with the signal characteristics corresponding to the continuous tapping actions means that the signal waveform morphological characteristics of the plurality of elastic wave signals satisfy one or more of the following conditions:
condition 1: each of the elastic wave signals includes double endpoints;
condition 2: for the plurality of elastic wave signals, the total quantity of peak points whose values are greater than the preset baseline Ta is the same as the quantity of the plurality of elastic wave signals; the duration T1 is within a first preset time range;
condition 3: the duration T2 is within a second preset time range;
condition 4: the duration T3 is within a third preset time range;
the above first preset time range, the second preset time range, and the third preset time range may be estimated empirically;
condition 5: the duration T1 is less than the duration T2, and the duration T2 is less than the duration T3;
condition 6: a time difference between occurrence moments of peak points of two adjacent elastic wave signals is within a preset time range;
condition 7: a frequency corresponding to a median value of a spectrum energy of each elastic wave signal is located in a preset frequency range, and the preset frequency range is [80 Hz, 2000 Hz];
condition 8: a sum of all frequency energies less than or equal to a preset frequency threshold F in the plurality of elastic wave signals is less than a preset energy sum threshold, where 0 Hz≤F≤25 Hz;
condition 9: all energy mean values of the plurality of elastic wave signals in a first frequency band are greater than all energy mean values of the plurality of elastic wave signals in a second frequency band, and a maximum value of frequency amplitudes of the first frequency band is greater than a maximum value of frequency amplitudes of the second frequency band.

Taking the graph shown in FIG. 5 as an example, signal waveform morphological characteristics of a plurality of elastic wave signals being consistent with signal characteristics corresponding continuous tapping actions will be illustrated.
Way 1: analyzing a signal waveform morphological characteristic 1, that is, performing double endpoint verification on each elastic wave signal: an elastic wave signal generated by each tapping action has a start point and an end point; after the verification, a quantity of the start points and a quantity of the end points of the elastic wave signals shown in FIG. 5, and indices corresponding to the start point and end point of each elastic wave signal are 2, 2, 50, 76, 286, and 312, respectively.
Way 2: analyzing a signal waveform morphological characteristic 2, analyzing a total quantity of peak points located above the preset baseline Ta and the duration T1 in which each elastic wave signal is greater than or equal to the preset baseline Ta; Ta=e*(NIS+f) where e and f are set to 5 and 3 respectively, and NIS takes a maximum value of the first five sampling points of the signals shown in FIG. 5, which is 0.86; the Ta value is 19.3. In the elastic wave signals shown in FIG. 5, the total quantity of peak points located above the preset baseline Ta is 2, and the duration in which each elastic wave signal is greater than or equal to the preset baseline Ta is T1₁=5 ms and T1₂=5 ms respectively.
Way 3: analyzing a signal waveform morphological characteristic 3, and analyzing a duration of each elastic wave signal greater than or equal to the preset baseline Tc, that is, the duration T2 of each elastic wave signal; for a first elastic wave signal, Tc₁=Ta+(P₁−Ta)/2=19.3+(57.6−19.3)/2=38.5, and a duration T2₁ greater than or equal to Tc₁ is 3 ms; for a second clastic wave signal, Tc₂=Ta+(P₂−Ta)/2=19.3+(67.2−19.3)/2=43.3, and a duration T2₂ greater than or equal to Tc₂ is 3 ms; wherein P₁ and P₂ are a peak value of the first elastic wave signal and a peak value of the second elastic wave signal respectively.
Way 4: analyzing a signal waveform morphological characteristic 4, analyzing a total duration T3 for which the plurality of elastic wave signals are greater than the preset baseline Tb.
Way 5: analyzing a signal waveform morphological characteristic 5, and analyzing a magnitude relation between the duration T1, the duration T2, and the total duration T3; for continuous elastic wave signals, each elastic wave signal needs to satisfy T1-T2>threshold a and T2/T1<threshold b, that is, each elastic wave signal satisfies damping attenuation characteristics, and the plurality of elastic wave signals satisfy T3-T1>threshold c.
Way 6: analyzing a signal waveform morphological characteristic 6, and analyzing a time difference between the peak points of two adjacent elastic wave signals; the time difference should not be too small or too large, and should satisfy a preset time condition, which can be obtained through experiments; in FIG. 5, the time difference between the two peaks P₁ and P₂ is 236 ms, which satisfies the preset time condition.
Way 7: analyzing a signal waveform morphological characteristic 7, and analyzing a frequency corresponding to a median value of the spectrum energy of each elastic wave signal; summing up the spectral amplitude of each elastic wave signal and multiplying it by half to calculate a frequency value corresponding to the median value of the spectrum energy, and a median value of a spectrum energy of an elastic wave signal generated by a real tapping action is within about 80 Hz to 2 kHz in the range.
Way 8: analyzing a signal waveform morphological characteristic 8, analyzing a sum of all frequency energies less than or equal to the preset frequency threshold F in the plurality of elastic wave signals, 0 Hz<F≤25 Hz; this characteristic focuses on a sum of frequency energy of low frequency channels in the plurality of elastic wave signals, and when the plurality of elastic wave signals are elastic wave signals generated by the real tapping actions, a sum of energy of low frequency channels thereof needs to be less than a preset sum threshold of energy.
Way 9: analyzing a signal waveform morphological characteristic 9, and analyzing ratios of all energy mean values of the plurality of clastic wave signals in the frequency band [1600 Hz, 2000 Hz] to all energy mean values of the plurality of elastic wave signals in the frequency band [190 Hz, 1200 Hz]; when the plurality of elastic wave signals are the elastic wave signals generated by the real tapping actions, all energy mean values of the plurality of elastic wave signals in the frequency band [1600 Hz, 2000 Hz] are smaller than all energy mean values of the plurality of clastic wave signals in the frequency band [190 Hz, 1200 Hz], and a maximum value of frequency amplitudes of the plurality of elastic wave signals in the frequency band [1600 Hz, 2000 Hz] is smaller than a maximum value of frequency amplitudes of the plurality of clastic wave signals in the frequency band [190 Hz, 1200 Hz].

In an exemplary embodiment, performing signal cross-correlation characteristic analysis on the plurality of elastic wave signals includes one or more of the following ways:
way 1: analyzing Pearson correlation coefficients of two adjacent elastic wave signals in at least one of the time domain or the frequency domain; the Pearson correlation coefficient can measure a degree of linear correlation between the two clastic wave signals; a value of the Pearson correlation coefficient is between −1 and 1, wherein when the Pearson correlation coefficient is equal to 1, it represents a completely positive correlation; when the Pearson correlation coefficient is equal to −1, it represents a completely negative correlation; when the Pearson correlation coefficient is equal to 0, it represents that there is no linear correlation;
way 2: analyzing mutual information of two adjacent elastic wave signals in at least one of the time domain or the frequency domain. The mutual information (MI) can be used to quantify a degree of interdependence between the two elastic wave signals. When the two clastic wave signals are completely independent, their mutual information is 0, and when one elastic wave signal can be completely determined by another elastic wave signal, their mutual information reaches a maximum value.

Taking FIG. 5 as an example, at least one of a Pearson correlation coefficient and mutual information in time domain raw signals of two taps can be calculated, or at least one of a Pearson correlation coefficient and a mutual information of short-term energy value signals in the time domain of the two taps can be calculated; or at least one of a Pearson correlation coefficient and mutual information of frequency domain signals of the two taps can be calculated.

In an exemplary embodiment, based on the ways of performing signal cross-correlation characteristic analysis on the plurality of elastic wave signals, the signal cross-correlation characteristics being consistent with the signal characteristics corresponding to the continuous tapping actions means that the signal cross-correlation characteristics of the plurality of elastic wave signals satisfies one or more of the following conditions:
condition 1: the Pearson correlation coefficient is greater than or equal to a preset coefficient value A, and 0.4≤A≤0.5, which means that for the continuous tapping actions, the plurality of elastic wave signals need to have at least a medium intensity cross correlation;
condition 2: the mutual information is greater than 0.

In an example embodiment, the tapping action recognition method applied to the vehicle further includes:
when it is determined that the real tapping actions on the vehicle have occurred, determining whether tapping positions corresponding to the real tapping actions are within a preset tapping range.

When it is determined that the real tapping actions on the vehicle have occurred, responding to the tapping actions includes:
responding to the tapping actions if the tapping positions are within the preset tapping range;
not responding to the tapping actions if the tapping positions are outside the preset tapping range.

In an exemplary embodiment, determining whether the tapping positions corresponding to the real tapping actions are within the preset tapping range includes:
determining whether the tapping positions are within the preset tapping range based on signal characteristics of a plurality of frequency components having different propagation speeds included in the elastic wave signals generated by the real tapping actions;
when an elastic wave signal propagates in a medium, its waveform is usually a complex waveform composed of multiple sine waves with different frequency components; the signal characteristics of the plurality of frequency components having different propagation speeds refer to signal characteristics that the plurality of frequency components having different propagation speeds present due to a dispersion effect;
wherein the plurality of frequency components having different propagation speeds included in the elastic wave signals may be separated by a band-pass filter; the band-pass filter can be implemented by software, for example, an algorithm can be written using a programming language and a special signal processing library to filter the elastic wave signals; the band-pass filter can also be implemented by hardware, such as using electronic elements (such as resistors, capacitors, inductors, operational amplifiers, etc.) to build an analog filter circuit;
wherein the dispersion effect means that the higher the frequency, the higher the propagation speeds of the frequency component signals, the shorter the times for the frequency component signals to reach the elastic wave sensor from the tapping positions, and the greater the attenuation of the frequency component signals.

A high-frequency signal and a low-frequency signal mentioned in the embodiments of the present disclosure are relative concepts, and do not represent a specific frequency range. The high-frequency signal and the low-frequency signal can be understood as a frequency point signal or a frequency band signal.

According to the method provided by the embodiment of the present disclosure, tapping positioning is performed based on signal characteristics of an elastic wave signal itself, and the signal characteristics can be obtained even if there is only one sensor; this method can satisfy the requirements of positioning accuracy and reduce the dependence on a quantity of sensors.

In an exemplary embodiment, due to an existence of the dispersion effect, there is a time difference between the high-frequency signal and the low-frequency signal included in the elastic wave signal reaching the elastic wave sensor from the tapping position, and different tapping positions correspond to different time differences. Based on this understanding, in an exemplary embodiment, determining whether the tapping positions are within the preset tapping range based on signal characteristics of the plurality of frequency components having the different propagation speeds included in the elastic wave signals generated by the real tapping actions includes:
separating a first frequency component signal and a second frequency component signal from the elastic wave signals, and a frequency of the first frequency component signal is less than a frequency of the second frequency component signal; in this embodiment, the first frequency component signal may be a low-frequency signal, and the second frequency component signal may be a high-frequency signal;
determining a first time difference between the first frequency component signal and the second frequency component signal reaching the elastic wave sensor;
determining whether the tapping position is within the preset tapping range based on the first time difference.

In an exemplary embodiment, the method of separating the first frequency component signal and the second frequency component signal from the elastic wave signal includes:
when the quantity of the elastic wave sensor is one, as shown in FIG. 6, separating the first frequency component signal and the second frequency component signal from the elastic wave signal collected by the elastic wave sensor through the band-pass filter;
when the quantity of the elastic wave sensors is two, separating the first frequency component signal from an elastic wave signal collected by one of the clastic wave sensors through a band-pass filter; separating the second frequency component signal from an elastic wave signal collected by another elastic wave sensor by a band-pass filter. A distance between the two elastic wave sensors is smaller than a preset distance.

In an example embodiment, the separating the first frequency component signal and the second frequency component signal from the elastic wave signals includes:
determining two target frequency points based on a waveform of an elastic wave signal in the frequency domain, wherein one of the two target frequency points is a main peak point, the main peak point generally refers to a point with a largest amplitude, and the other of the two target frequency points is another peak point whose interval from the main peak point is greater than a preset frequency domain bandwidth;
determining a first frequency band based on a target frequency point having a smaller frequency of the two target frequency points and a preset first bandwidth, and determining a second frequency band based on a target frequency point having a larger frequency of the two target frequency points and a preset second bandwidth; for example, a setting principle of the preset first bandwidth and the preset second bandwidth is the same, and both of them need to include a target frequency point, and two ends of a frequency bandwidth are equally separated from the target frequency point; widths of the first bandwidth and of the second bandwidth are adjustable, and when they are 0, the first frequency band and the second frequency band are corresponding target frequency points;
based on the first bandwidth and the second bandwidth, setting corresponding band-pass filters, and separating the first frequency component signal and the second frequency component signal from the elastic wave signal by the band-pass filters. The band-pass filters can separate the first frequency component signal and the second frequency component signal from the elastic wave signal in the time domain, for example, for conventional FIR, time domain signals can be filtered after filter coefficients for IIR filters being designed; the band-pass filters may also separate the first frequency component signal and the second frequency component signal from the elastic wave signal in the frequency domain.

In an example embodiment, determining the first time difference between the first frequency component signal and the second frequency component signal reaching the elastic wave sensor includes:
calculating envelope signals of the first frequency component signal and the second frequency component signal respectively;
taking a time difference between same phase points in the two envelope signals as the first time difference.

For example, peak points or valley points of two envelope signals may be selected as same phase points of the two envelope signals. Since peaks and valleys are prominent characteristics of a signal and have high recognition, by selecting the peak points or valley points as synchronization points, an accuracy of synchronization between the two signals can be improved and the two signals can be ensured to remain consistent in phase. Detection of the peak points and the valley points is usually simpler than a complex phase tracking algorithm. By using the peak points or the valley points, a signal processing algorithm can be simplified, and a computational complexity can be reduced. In addition, the peak points and the valley points have good robustness to noise and signal fluctuations, and even when the signal is disturbed, the peak points and the valley points are still easy to recognize, which helps to maintain a stability of signal synchronization by selecting the peak points or the valley points as the synchronization points.

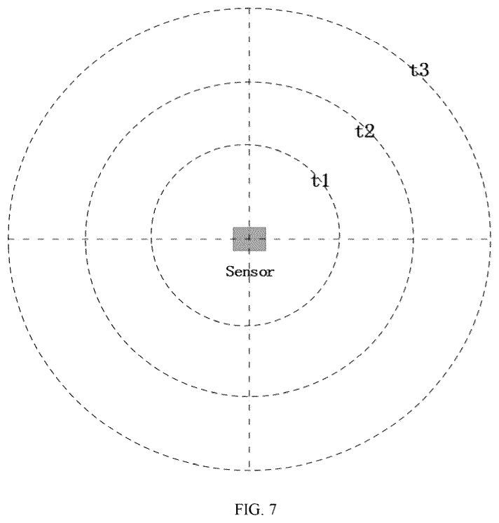

In an example embodiment, determining whether the tapping position is within the preset tapping range based on the first time difference includes:
determining the tapping position corresponding to the first time difference based on a correspondence relationship between a time difference between the first frequency component signal and the second frequency component signal reaching the elastic wave sensor and a known tapping position; FIG. 7 shows a schematic diagram of a correspondence relationship between a time difference between two different frequency component signals reaching an elastic wave sensor and a known tapping position; in FIG. 7, the sensor is taken as a center of circles, and concentric circles with different radii represent tapping positions with different distances from the sensor; tapping positions on a same concentric circle have a same distance from the sensor; each concentric circle corresponds to a time difference; and different concentric circles correspond to different time differences;
judging whether the tapping position is within the preset tapping range.

In an example, the determining whether the tapping position is within the preset tapping range based on the first time difference includes:
determining whether the first time difference is less than or equal to a preset time difference threshold;
when the first time difference is less than or equal to the preset time difference threshold, determining that the tapping position corresponding to the first time difference is within the preset tapping range;
when the first time difference is greater than the preset time difference threshold, determining that the tapping position corresponding to the first time difference is outside the preset tapping range;
the preset time difference threshold is determined based on a time difference between the first frequency component signal and the second frequency component signal reaching the elastic wave sensor from a boundary of the preset tapping range.

Hereinafter, by way of an example, the method of determining whether the tapping position is within the preset tapping range by using the time difference between a signal of different frequency components reaching the elastic wave sensor described in the above-described embodiment will be illustrated.

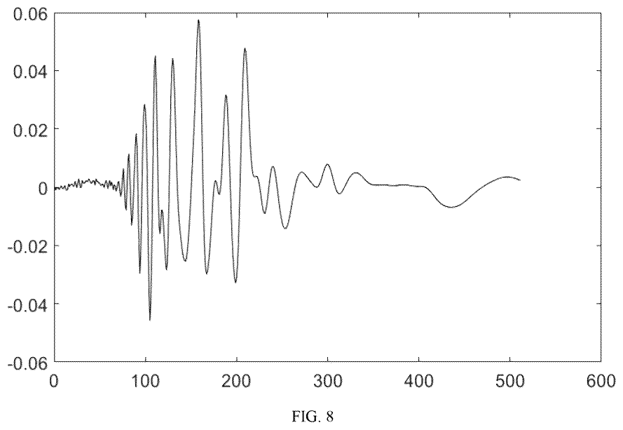

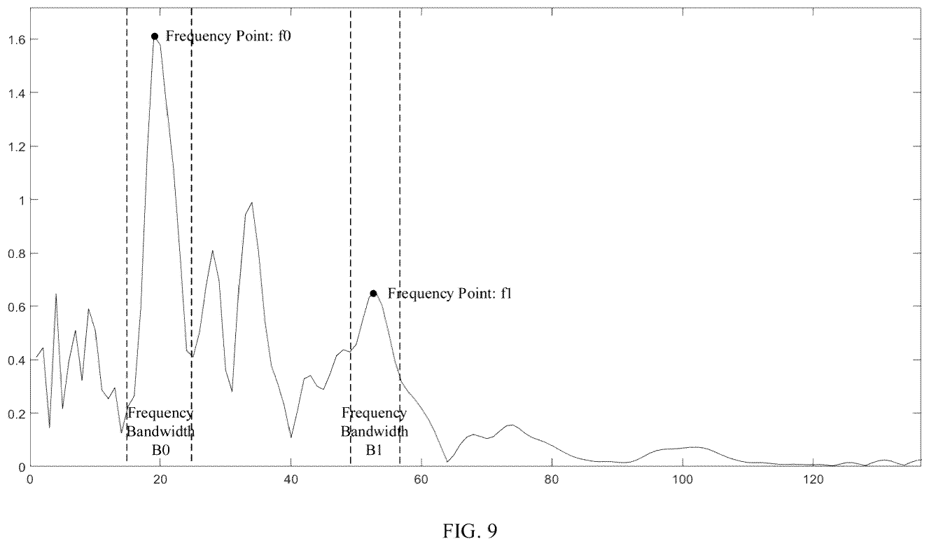

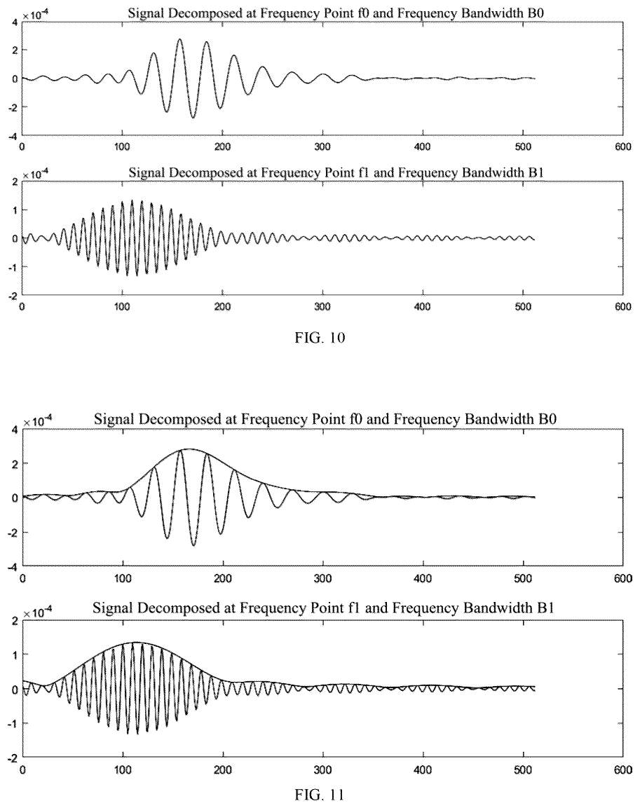

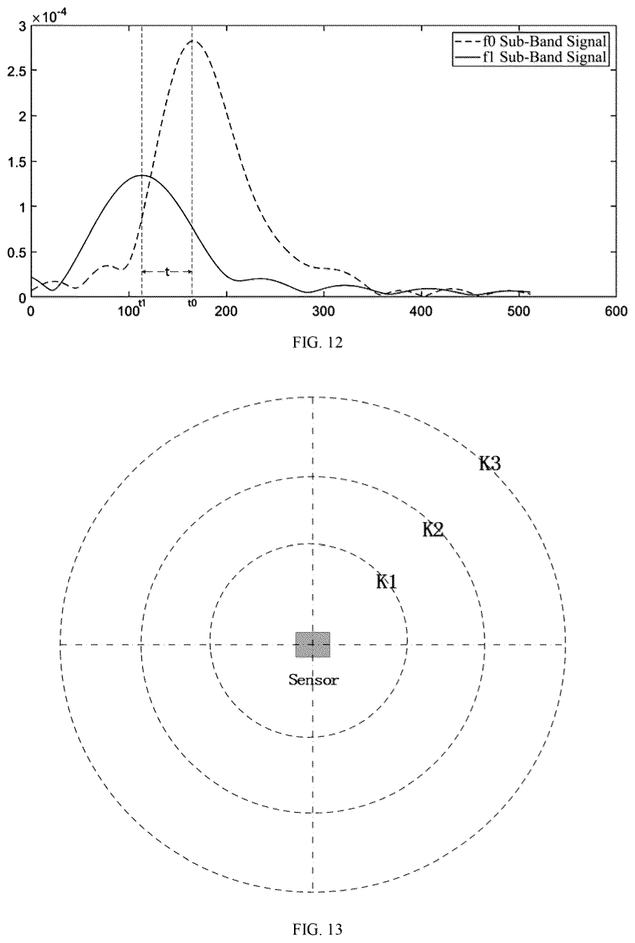

Taking a layout of the clastic wave sensor shown in FIG. 6 as an example, an elastic wave signal greater than a preset collection threshold and having a predetermined length is collected by an elastic wave sensor, as shown in FIG. 8, in which horizontal coordinates represent times and longitudinal coordinates represent amplitudes of the elastic wave signal;
performing time-frequency transformation on time domain signal shown in FIG. 8, and the transformed frequency domain clastic wave signal is shown in FIG. 9; selecting a main peak point from the frequency domain clastic wave signal as one of the target frequency points f0, and selecting a peak point distant from the target frequency point f0 by a preset frequency domain bandwidth as another target frequency point f1; selecting a first frequency band having a bandwidth of B0 with f0 as a center frequency point; and selecting a second frequency band having a frequency bandwidth B1 with f1 as a center frequency point;
separating the first frequency component signal having a first frequency band B0 and the second frequency component signal having a second frequency band B1 from the elastic wave signal by band-pass filters, as shown in FIG. 10;
respectively calculating the envelope signals of the first frequency component signal and the second frequency component signal, as shown in FIG. 11;
calculate a time difference between peak points of two envelope signals, where t in FIG. 12 is a time difference;
in combination with the correspondence relationship between the different t and the tapping positions shown in FIG. 7, it is possible to determine whether a tapping position corresponding to a time difference t in FIG. 12 is within the preset tapping range. When frequencies of selected two frequency component signals are changed, values of time differences corresponding to a same tapping position are also different, so in actual implementation, after the correspondence relationship between the time difference and the tapping position is determined, the frequencies of the selected first frequency component signal and second frequency component signal are also recorded, and then the first frequency component signal and the second frequency component signal with a same frequency are filtered out from the clastic wave signal in a subsequent tapping positioning process to ensure accurate positioning.

Due to the existence of dispersion effect, there is not only a time difference between the time when the clastic wave sensor receives the high-frequency signal and the low-frequency signal, but also attenuation degrees of the received high-frequency signal and the low-frequency signal are different, so there are also differences in characteristic values (such as amplitudes and energy values) of the received high-frequency signal and the low-frequency signal, and the differences corresponding to different tapping positions are different. Based on this understanding, in another embodiment, the determining whether the tapping position is within the preset tapping range based on signal characteristics of the plurality of frequency components having the different propagation speeds included in the elastic wave signals\ includes:
selecting a signal segment of a preset frequency range in the elastic wave signal;
determining a first slope from an initial signal characteristic value to a maximum signal characteristic value of the signal segment, wherein a frequency of a frequency component corresponding to the initial signal characteristic value is greater than a frequency of a frequency component corresponding to the maximum signal characteristic value based on a characteristic that a frequency component signal having a higher frequency propagates faster;
based on the first slope, determining whether the tapping position is within the preset tapping range.

In an exemplary embodiment, the selecting the signal segment of the preset frequency range in the elastic wave signal includes:
filtering the elastic wave signal using a preset band-pass filter, and taking a wave head signal having a predetermined length in the filtered elastic wave signal as the signal segment of the preset frequency range; wherein a start point of the wave head signal is a first point greater than a preset amplitude threshold, the wave head signal includes dominant peaks of the filtered elastic wave signal in a time domain waveform; an amplitude of the start point is the initial signal characteristic value, and the main peak is a maximum signal characteristic value.

In an exemplary embodiment, determining the first slope from the initial signal characteristic value to the maximum signal characteristic value of the signal segment includes:
taking a slope of a straight line connecting the initial signal characteristic value and the maximum signal characteristic value as the first slope.

In an exemplary embodiment, determining the first slope from the initial signal characteristic value to the maximum signal characteristic value of the signal segment includes:
obtaining a set of signal characteristic value incremental points based on signal absolute values of the signal segment;
fitting the set of the signal characteristic value incremental points to obtain a fitted straight line, and taking a slope of the fitted straight line as the first slope.

Considering that the elastic wave signal may be affected by noise, in this embodiment, the slope is obtained by fitting a straight line, and compared with a method in which the slope is obtained by directly connecting two points of the initial signal characteristic value and the maximum signal characteristic value, a slope error caused by noise can be reduced.

In an exemplary embodiment, determining whether the tapping position is within the preset tapping range based on the first slope includes:
determining whether the first slope is greater than or equal to a preset slope threshold;
when the first slope is greater than or equal to the preset slope threshold, determining that a tapping position corresponding to the first slope is within the preset tapping range;
when the first slope is less than the preset slope threshold, determining that the tapping position corresponding to the first slope is outside the preset tapping range;
determining the preset slope threshold based on a slope from a boundary of the preset tapping range to the elastic wave sensor determined by the signal segment.

FIG. 13 shows a schematic diagram of a correspondence relationship between a slope determined based on two different frequency component signals and known tapping positions. In FIG. 13, the sensor is taken as the center, and concentric circles of different radii represent tapping positions at different distances from the sensor, the tapping positions on a same concentric circle are at a same distance from the sensor. Each concentric circle corresponds to a slope, and different concentric circles correspond to different slopes.

Hereinafter, by way of an example, the method of determining whether the tapping position is within the preset tapping range based on the slope determined by different frequency component signals described in the above-described embodiment will be illustrated.

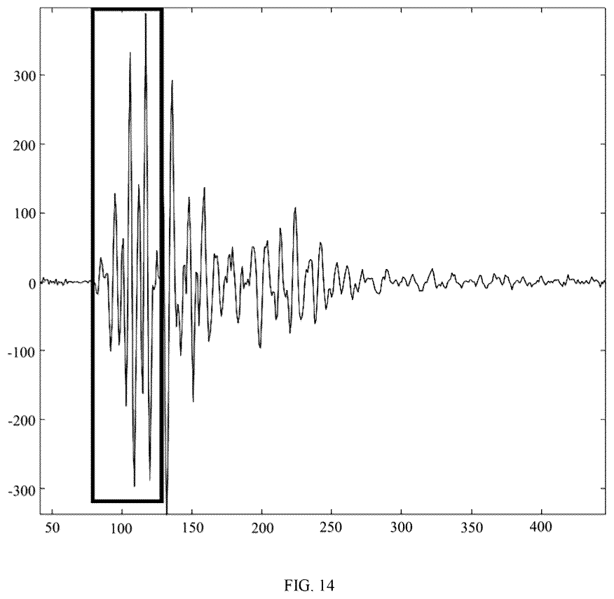

Similarly, taking the layout of the elastic wave sensor shown in FIG. 6 as an example, the elastic wave signal is filtered by using a preset band-pass filter, and the filtered elastic wave signal is shown in FIG. 14, in which horizontal coordinates represent times and longitudinal coordinates represent amplitudes of the elastic wave signal.

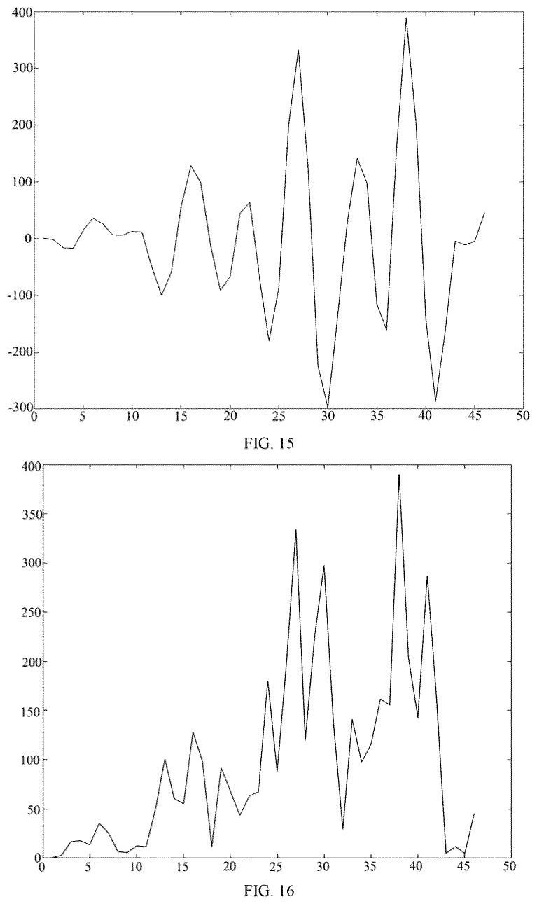

Wave head signals of a predetermined length are selected from the filtered elastic wave signal, as shown in the black frame in FIG. 14, and the signals in the black box in FIG. 14 are amplified, as shown in FIG. 15.

Taking absolute values of the wave head signals, the obtained signals are shown in FIG. 16.

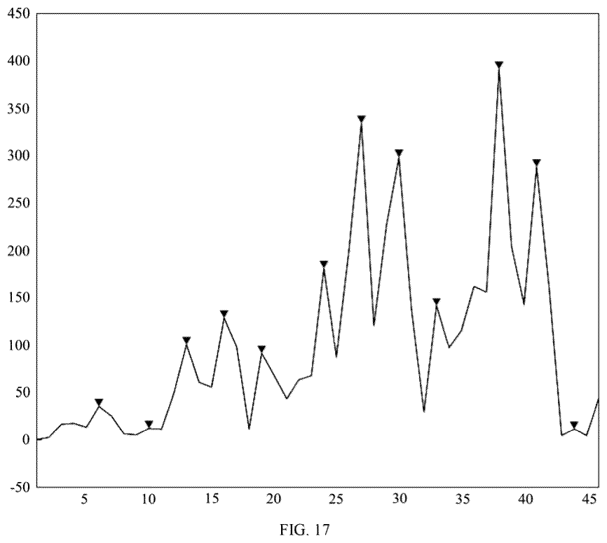

Peak points are determined based on the absolute values of the wave head signals, as shown in FIG. 17.

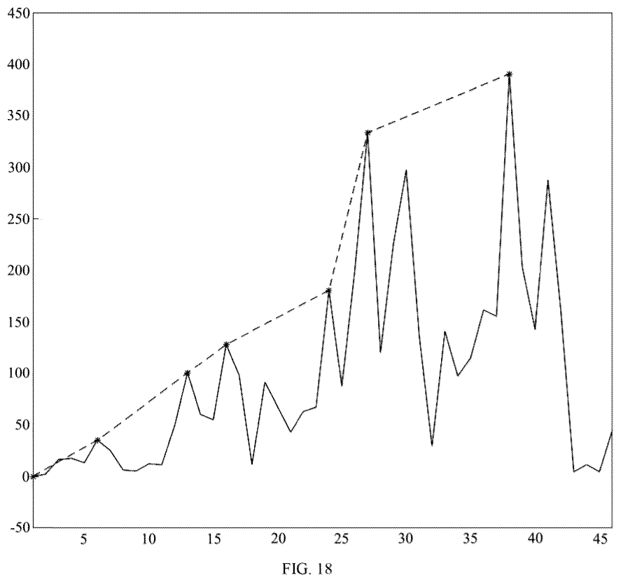

A set of peak points with increasing values is selected from a plurality of peak points, as shown in FIG. 18.

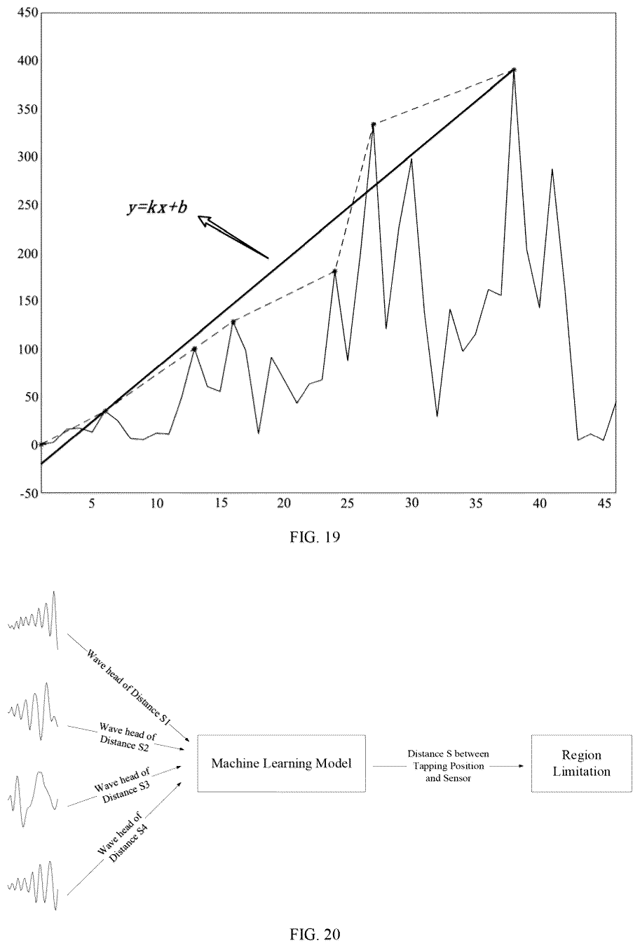

A fitting straight line of this set is calculated by using one-dimensional linear regression model, as shown in FIG. 19.

A slope value k of the straight line is calculated, which is the obtained first slope.

In actual implementation, a grid can be calibrated on a touch panel, tapping points at different distances from the sensor can be designed, and a k value template of the whole touch panel can be obtained. The template can be shown in FIG. 13. In actual tapping positioning, it is determined whether the tapping position is within the preset tapping range by comparing the calculated k value with a k value in the module.

Due to an existence of dispersion effect, morphology of elastic wave signals collected by the elastic wave sensors from different tapping positions are also different. Based on this understanding, in another embodiment, the determining whether the tapping position is within the preset tapping range based on signal characteristics of the plurality of frequency components having different propagation speeds included in the elastic wave signals includes:
determining a first morphology of the elastic wave signal from signal characteristics of the plurality of frequency components having different propagation speeds;
determining a tapping position corresponding to the first morphology based on a correspondence relationship between a morphology of the elastic wave signal and a known tapping position;
judging whether the tapping position is within the preset tapping range.

In an exemplary embodiment, determining the tapping position corresponding to the first morphology based on the correspondence relationship between the morphology of the elastic wave signal and the known tapping position includes:
inputting the first morphology of the elastic wave signal into a machine learning model to obtain the tapping position corresponding to the first morphology, wherein the machine learning model is trained based on the known tapping position and the morphology of the corresponding elastic wave signal thereof.

The schematic diagram of train the machine learning model is shown in FIG. 20. Inputting the elastic wave signals obtained by tapping at the plurality of known positions to the machine learning model to be trained as learning samples can help the machine learning module to establish a correspondence relationship between morphology of the elastic wave signals and the tapping positions.

The tapping action recognition method applied to the vehicle described in the embodiments of the present disclosure, can be applied to opening and closing operations of a front (rear) trunk of the vehicle, for example, when the front (rear) trunk of the vehicle is in a closed state, if it is determined that the real tapping actions on the vehicle have occurred by the tapping action recognition method applied to the vehicle described in the present disclosure, the front (rear) trunk can be opened; when the front (rear) trunk of the vehicle is opened, if it is determined that the real tapping actions on the vehicle have occurred by the tapping action recognition method applied to the vehicle described in the present disclosure, the front (rear) trunk can be closed, which is convenient to operate.

Embodiments of the present disclosure further provide a non-transitory computer readable storage medium storing one or more program instructions executable by one or more processors to implement the tapping action recognition method applied to the vehicle as described in any previous embodiment.

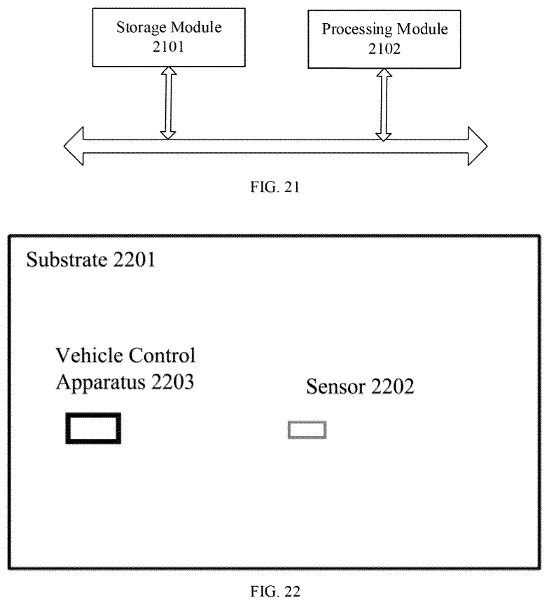

Embodiments of that present disclosure further provide a vehicle control apparatus, as shown in FIG. 21, the apparatus including:
a storage module 2101 configured to store computer program instructions executable on a processor;
a processing module 2102 configured to execute the computer program instructions to implement the tapping action recognition method applied to the vehicle as described in any previous embodiment.

Embodiments of that present disclosure further provide a vehicle control apparatus, as shown in FIG. 22, and the vehicle control apparatus includes:
a touch substrate 2201;
an elastic wave sensor 2202 provided in a preset region under the touch substrate 2201, wherein the preset region is a region within a preset distance range from a center point of the touch substrate 2201;
the vehicle control device 2203 as described in the previous embodiment and configured to receive elastic wave signals from the elastic wave sensor 2202.

Embodiments of the present disclosure further provide a vehicle, wherein a housing of the vehicle includes the vehicle control device as described in the previous embodiment.

Those of ordinary skill in the art may understand that all or some of the acts in the methods, systems, functional modules/units in the apparatus disclosed above may be implemented as software, firmware, hardware, and suitable combinations thereof. In a hardware implementation mode, division between functional modules/units mentioned in the above description does not necessarily correspond to division of physical components. For example, one physical component may have multiple functions, or one function or act may be performed by several physical components in cooperation. Some or all components may be implemented as software executed by a processor, such as a digital signal processor or microprocessor, or as hardware, or as an integrated circuit, such as an application specific integrated circuit. Such software may be distributed on a computer readable medium, which may include a computer storage medium (or non-transitory medium) and a communication medium (or transitory medium). As is well known to those of ordinary skill in the art, the term “computer storage medium” includes volatile and non-volatile, removable and non-removable media implemented in any method or technique for storing information (such as computer readable instructions, data structures, program modules, or other data). The computer storage medium includes, but is not limited to, RAM, ROM, EEPROM, a flash memory or another memory technology, CD-ROM, a Digital Versatile Disk (DVD) or other optical disk storage, a magnetic cartridge, a magnetic tape, magnetic disk storage or another magnetic storage apparatus, or any other medium that may be used to store desired information and may be accessed by a computer. In addition, it is well known to those of ordinary skill in the art that the communication medium typically contains computer readable instructions, a data structure, a program module, or other data in a modulated data signal such as a carrier wave or another transmission mechanism, and may include any information delivery medium.

1. A tapping action recognition method applied to a vehicle which is provided with an elastic wave sensor, the method comprising:
receiving elastic wave signals captured by the elastic wave sensor;
determining, based on at least the elastic wave signals, whether a preset quantity of tapping actions on the vehicle have occurred within a preset time period;
determining whether the preset quantity of tapping actions are real tapping actions; and
responding to the tapping actions when it is determined that the real tapping actions on the vehicle have occurred.

2. The method according to claim 1, wherein,
receiving the elastic wave signals captured by the elastic wave sensor comprises: receiving the elastic wave signals collected by the elastic wave sensor when the vehicle is in a sleep state or a wake-up state;
the method further comprises: first comparing signal strengths of the elastic wave signals with a first threshold for triggering the vehicle to wake up and waking up the vehicle when a signal strength of an elastic wave signal is greater than the first threshold; when the vehicle is in the wake-up state, then performing the operations of: determining, based on at least the elastic wave signals, whether the preset quantity of tapping actions on the vehicle have occurred within the preset time period, and determining whether the preset quantity of tapping actions are the real tapping actions.

3. The method according to claim 1, wherein,
determining, based on at least the elastic wave signals, whether the preset quantity of tapping actions on the vehicle have occurred within the preset time period comprises:
monitoring the elastic wave signals, buffering a segment of an elastic wave signal of a predetermined length when a signal strength of the elastic wave signal is greater than a second threshold for triggering signal collection, and when it is determined that the segment of the elastic wave signal is an elastic wave signal generated by a single tapping action, recognizing the segment of the elastic wave signal as a single tapping signal and continuing to monitor the elastic wave signals;
when Num single tap signals are recognized within the preset time period, determining that the preset quantity of tapping actions on the vehicle have occurred within the preset time period; where Num is equal to the preset quantity, and Num is an integer greater than or equal to 1.

4. The method according to claim 1, wherein,
whether the preset quantity of tapping actions on the vehicle have occurred within the preset time period is determined based on the elastic wave signals, and whether the preset quantity of tapping actions are the real tapping actions is determined based on the elastic wave signals; or
the method further comprises: acquiring perception information within a target time and a target space in which the tapping actions occur;
whether the preset quantity of tapping actions on the vehicle have occurred within the preset time period is determined based on the elastic wave signals, and whether the preset quantity of tapping actions are the real tapping actions is determined based on the elastic wave signals and the perception information, or based on the perception information alone.

5. The method according to claim 4, wherein,
determining, based on the elastic wave signals, whether the preset quantity of tapping actions are the real tapping actions comprises: determining whether the preset quantity of tapping actions are the real tapping actions when a matching degree between waveforms of the elastic wave signals generated by the preset quantity of tapping actions are greater than a preset first matching degree threshold;
determining, based on the elastic wave signals and the perception information, whether the preset quantity of tapping actions are the real tapping actions comprises: determining whether the preset quantity of tapping actions are the real tapping actions further based on the perception information when the matching degree between waveforms of the elastic wave signals generated by the preset quantity of tapping actions are greater than a preset second matching degree threshold, wherein the second matching degree threshold is less than or equal to the first matching degree threshold.

6. The method according to claim 5, wherein,
determining, based on the perception information, whether the preset quantity of tapping actions are the real tapping action comprises any one of following:
the perception information comprises information on whether a human body is detected, and determining whether a human body is detected within the target time and the target space based on the perception information; wherein when the human body is detected, it is determined that the preset quantity of tapping actions are the real tapping actions; and when the human body is not detected, it is determined that the preset quantity of tapping actions are not the real tapping actions;
the perception information comprises portrait information, and the portrait information comprises dynamic posture characteristics of the human body; determining whether there is timing synchronization between the dynamic posture characteristics and the tapping actions: wherein when there is the timing synchronization between the dynamic posture characteristics and the tapping actions, it is determined that the preset quantity of tapping actions are the real tapping actions; and when there is no timing synchronization between the dynamic posture characteristics and the tapping actions, it is determined that the preset quantity of tapping actions are not the real tapping actions;
the perception information comprises portrait information comprising static facial characteristics of the human body; determining whether the static facial characteristics are static facial characteristics of a legitimate user: wherein when the static facial characteristics are the static facial characteristics of the legitimate user, it is determined that the preset quantity of tapping actions are the real tapping actions; when the static facial characteristics are not the static facial characteristics of the legitimate user, it is determined that the preset quantity of tapping actions are not the real tapping actions; the perception information comprises sound information, and the sound information comprises tapping sound information; determining whether there is timing synchronization between the tapping sound information and the tapping actions; wherein when there is timing synchronization between the tapping sound information and the tapping actions, it is determined that the preset quantity of tapping actions are the real tapping actions; when there is no timing synchronization between the tapping sound information and the tapping actions, it is determined that the preset quantity of tapping actions are not the real tapping actions.

7. The method according to claim 1, further comprising:
acquiring perception information within a target time and a target space at which the tapping actions occur, wherein the perception information comprises at least one of portrait information and sound information; the portrait information comprises: at least one of dynamic posture characteristics of a human body and static facial characteristics of the human body; the sound information comprises tapping sound information;
wherein whether the preset quantity of tapping actions on the vehicle have occurred within a preset time period and whether the preset quantity of tapping actions are the real tapping actions are determined based on both of the elastic wave signals and the perception information, and the method further comprises:
performing timestamp alignment and spatial calibration of the perception information and the single tapping signals to obtain synchronization data, wherein the synchronization data comprises at least one of time domain characteristics and frequency domain characteristics of the single tapping signals, and at least one of portrait characteristics acquired from the portrait information and sound characteristics acquired from the sound information; the single tapping signals are elastic wave signals generated by single tapping actions; and
inputting the synchronization data into a trained neural network model, and determining, based on an output of the neural network, whether the preset quantity of tapping actions on the vehicle have occurred within the preset time period and the preset quantity of tapping actions are the real tapping actions.

8. The method according to claim 1, further comprising:
determining whether tapping positions corresponding to the real tapping actions are within a preset tapping range when it is determined that the real tapping actions on the vehicle have occurred;
responding to the tapping actions if tapping positions are within the preset tapping range;
not responding to the tapping actions if the tapping positions are outside the preset tapping range.

9. The method according to claim 8, wherein,
determining whether the tapping positions corresponding to the real tapping actions are within the preset tapping range comprises:
determining whether the tapping positions are within the preset tapping range based on signal characteristics of a plurality of frequency components having different propagation speeds comprised in the elastic wave signals generated by the real tapping actions;
wherein the signal characteristics of the plurality of frequency components having different propagation speeds refer to signal characteristics that the plurality of frequency components having the different propagation speeds present due to a dispersion effect;
wherein the dispersion effect means that the higher the frequency, the faster the propagation speeds of the frequency component signals, the shorter the time for the frequency component signals to reach the elastic wave sensor from the tapping positions, and the greater the attenuation of the frequency component signals.

10. The method according to claim 9, wherein,
determining whether the tapping positions are within the preset tapping range based on the signal characteristics of the plurality of frequency components having the different propagation speeds comprised in the elastic wave signals generated by the real tapping actions comprises:
separating a first frequency component signal and a second frequency component signal from the elastic wave signals, wherein a frequency of the first frequency component signal is less than a frequency of the second frequency component signal; determining a first time difference between the first frequency component signal and the second frequency component signal reaching the elastic wave sensor; determining whether a tapping position is within the preset tapping range based on the first time difference; or
selecting a signal segment of a preset frequency range in an elastic wave signal; determining a first slope from an initial signal characteristic value to a maximum signal characteristic value of the signal segment, wherein a frequency of a frequency component corresponding to the initial signal characteristic value is greater than a frequency of a frequency component corresponding to the maximum signal characteristic value; and determining, based on the first slope, whether the tapping position is within the preset tapping range; or
determining a first morphology of the elastic wave signal based on the signal characteristics of the plurality of frequency components having the different propagation speeds; determining a tapping position corresponding to the first morphology based on a correspondence relationship between a morphology of the elastic wave signal and a known tapping position; and judging whether the tapping position is within the preset tapping range.

11. The method according to claim 10, wherein,
the vehicle is provided with one elastic wave sensor or two elastic wave sensors;
when two elastic wave sensors are provided, separating the first frequency component signal and the second frequency component signal from the elastic wave signal comprises:
separating the first frequency component signal from an elastic wave signal collected by one of the elastic wave sensors;
separating the second frequency component signal from an elastic wave signal collected by the other of the elastic wave sensors;
wherein separating frequency component signals from the elastic wave signal comprises:
determining two target frequency points based on a waveform of an elastic wave signal in the frequency domain, wherein one of the two target frequency points is a main peak point, and the other of the two target frequency points is another peak point whose interval from the main peak point is greater than a preset frequency domain bandwidth;
determining a first frequency band based on a target frequency point of the two target frequency points which has a smaller frequency and a preset first bandwidth, and determining a second frequency band based on a target frequency point of the two target frequency points which has a larger frequency and a preset second bandwidth; and
setting, based on the first bandwidth and the second bandwidth, corresponding band-pass filters, and separating the first frequency component signal and the second frequency component signal from the elastic wave signal by the band-pass filters.

12. The method according to claim 10, wherein,
determining the first time difference between the first frequency component signal and the second frequency component signal reaching the elastic wave sensor comprises:
calculating envelope signals of the first frequency component signal and the second frequency component signal respectively; taking a time difference between same phase points in the two envelope signals as the first time difference, which comprises: taking a time difference between peak points or valley points of the two envelope signals as the first time difference;
determining whether the tapping position is within the preset tapping range based on the first time difference comprises:
determining a tapping position corresponding to the first time difference based on a correspondence relationship between the time difference between the first frequency component signal and the second frequency component signal reaching the elastic wave sensor and a known tapping position; and judging whether the tapping position is within the preset tapping range; or
determining whether the first time difference is less than or equal to a preset time difference threshold; when the first time difference is less than or equal to the preset time difference threshold, determining that the tapping position corresponding to the first time difference is within the preset tapping range; when the first time difference is greater than the preset time difference threshold, determining that the tapping position corresponding to the first time difference is outside the preset tapping range.

13. The method according to claim 10, wherein,
determining the first slope from the initial signal characteristic value to the maximum signal characteristic value of the signal segment comprises:
obtaining a set of signal characteristic value incremental points based on signal absolute values of the signal segment; fitting the set of the signal characteristic value incremental points to obtain a fitted straight line, and taking a slope of the fitted straight line as the first slope; or
taking a slope of a straight line connecting the initial signal characteristic value and the maximum signal characteristic value as the first slope;
determining whether the tapping position is within the preset tapping range based on the first slope comprises:
determining whether the first slope is greater than or equal to a preset slope threshold; wherein when the first slope is greater than or equal to the preset slope threshold, it is determined that a tapping position corresponding to the first slope is within the preset tapping range; when the first slope is less than the preset slope threshold, it is determined that the tapping position corresponding to the first slope is outside the preset tapping range; and the preset slope threshold is determined based on a slope from a boundary of the preset tapping range to the elastic wave sensor determined from the signal segment.

14. The method according to claim 3, further comprising: determining environmental information using detection signals from vehicle sensors when monitoring the elastic wave signals, with the environmental information comprising at least one of:
ambient noise value;
information for judging an operating temperature of the elastic wave sensor;
performing at least one of following operations based on the environmental information:
adjusting the second threshold based on the ambient noise value, and increasing the second threshold when it is judged that the ambient noise value has increased; reducing the second threshold when it is determined that the ambient noise value has decreased;
when it is judged that the operating temperature of the elastic wave sensor exceeds a preset temperature threshold based on the information for judging the operating temperature of the elastic wave sensor, performing signal amplification on a current buffered segment of the elastic wave signal, and performing subsequent operations based on the buffered elastic wave signal.

15. The method according to claim 14, wherein,
determining the ambient noise value comprises at least one of following:
the vehicle sensors comprise a rain sensor, determining the ambient noise value based on a detection signal of the rain sensor;
the vehicle sensors comprise a vibration sensor, determining the ambient noise value based on a detection signal from the vibration sensor;
the vehicle sensors comprise the rain sensor and the vehicle sensor, determining the ambient noise value based on the detection signal from the rain sensor and the detection signal from the vibration sensor:
wherein determining the ambient noise value based on the detection signal from the rain sensor and the detection signal from the vibration sensor comprises:
determining a rain calibration value based on the detection signal from the rain sensor;
determining a vibration noise calibration value based on the detection signal from the vibration sensor;
performing a weighted summation on the rain calibration value and the vibration noise calibration value to obtain the ambient noise value, which comprises at least one of the following:
when the rain calibration value and the vibration noise calibration value are both greater than 0, the ambient noise value is jointly determined by the rain calibration value and the vibration noise calibration value, that is, weights for the rain calibration value and the vibration noise calibration value are both greater than 0;
when the rain calibration value is 0, the ambient noise value is determined only by the vibration noise calibration value, that is, a weight for the rain calibration value is 0, and a weight for the vibration noise calibration value is 1;
when the vibration noise calibration value is 0, the ambient noise value is determined only by the vibration noise calibration value, that is, the weight for the rain calibration value is 0, and the weight for the vibration noise calibration value is 1; or, when the vibration noise calibration value is 0, the ambient noise value is determined only by the rain calibration value, that is, the weight for the vibration noise calibration value is 0, and the weight for the rain calibration value is 1.

16. The method according to claim 15, wherein,
determining the vibration noise calibration value based on the detection signal from the vibration sensor comprises following periodic operations:
respectively determining background noise signal characteristic values of the vibration sensor within a plurality of second windows, wherein the plurality of second windows form a first window;
determining vibration noise calibration values corresponding to the plurality of second windows based on vibration noise intervals in which the background noise signal characteristic values in the plurality of second windows fall;
when more than a set quantity of second windows in the plurality of second windows corresponds to a same vibration noise calibration value, determining the same vibration noise calibration value as the vibration noise calibration value corresponding to the first window;
wherein a movement step size of the first window is equal to a window length of the second windows.

17. The method according to claim 14, further comprising:
after adjusting the second threshold based on the ambient noise value, if the ambient noise value is greater than or equal to a preset ambient noise threshold, determining an enabling state of tapping action recognition as de-enabling, stopping the tapping action recognition, and continuing the de-enabling for a preset de-enabling time period; switching the enabling state of the tapping action recognition to enabling when the preset de-enabling time period is met;
if the ambient noise value is smaller than the preset ambient noise threshold, determining the enabling state of the tapping action recognition as enabling, performing subsequent operations when the signal strength of the elastic wave signal is greater than the second threshold.

18. The method according to claim 1, wherein,
whether the preset quantity of tapping actions on the vehicle have occurred within the preset time period and whether the preset quantity of tapping actions are the real tapping actions are determined based on the elastic wave signals, which comprises:
performing a signal waveform morphological characteristic analysis and a signal cross-correlation characteristic analysis on a plurality of elastic wave signals acquired within the preset time period when the preset quantity is multiple;
when it is analyzed that signal waveform morphological characteristics and signal cross-correlation characteristics are consistent with signal characteristics corresponding to continuous tapping actions, determining that the preset quantity of real tapping actions on the vehicle have occurred within the preset time period.

19. The method according to claim 18, wherein,
performing the signal waveform morphological characteristic analysis on the plurality of elastic wave signals comprises one or more of the following ways:
way 1: performing double endpoint verification on each of the elastic wave signals;
way 2, for the plurality of elastic wave signals, analyzing a total quantity of peak points whose values are greater than a preset baseline Ta, and analyzing a duration T1 for which each elastic wave signal is greater than or equal to the baseline Ta; wherein the preset baseline Ta is: Ta=e*(NIS+f), where NIS is a maximum value of noise portions of the plurality of elastic wave signals, e and f are hyperparameters;
way 3: analyzing a duration T2 for which each elastic wave signal is greater than or equal to a preset baseline Tc, wherein the preset baseline Tc is greater than the preset baseline Ta; and the preset baseline Tc is: Tc=Ta+(P−Ta)/2 where P is a peak value of each elastic wave signal;
way 4: for the plurality of elastic wave signals, analyzing a total duration T3 for which values are greater than a preset baseline Tb, wherein the preset baseline Tb is determined based on a mean value of the plurality of elastic wave signals;
way 5: analyzing a magnitude relation between the duration T1, the duration T2, and the total duration T3;
way 6: analyzing a time difference between occurrence moments of peak points of two adjacent elastic wave signals;
way 7: analyzing a frequency corresponding to a median spectrum energy of each elastic wave signal;
way 8: analyzing a sum of frequency energies less than or equal to a preset frequency threshold F of the plurality of elastic wave signals;
way 9: analyzing all energy mean ratios of the plurality of elastic wave signals in a plurality of preset frequency bands;
wherein based on the ways of performing the signal waveform morphological characteristic analysis on the plurality of elastic wave signals, the signal waveform morphological characteristics being consistent with the signal characteristics corresponding to the continuous tapping actions means that the signal waveform morphological characteristics of the plurality of elastic wave signals satisfy one or more of following conditions:
condition 1: each of the elastic wave signals comprises double endpoints;
condition 2: for the plurality of elastic wave signals, the total quantity of peak points whose values are greater than the preset baseline Ta is the same as the quantity of the plurality of elastic wave signals; the duration T1 is within a first preset time range;
condition 3: the duration T2 is within a second preset time range;
condition 4: the duration T3 is within a third preset time range;
condition 5: the duration T1 is less than the duration T2, and the duration T2 is less than the duration T3;
condition 6: a time difference between occurrence moments of peak points of two adjacent elastic wave signals is within a preset time range;
condition 7: a frequency corresponding to a median value of a spectrum energy of each elastic wave signal is within a preset frequency range;
condition 8: a sum of all frequency energies less than or equal to a preset frequency threshold F of the plurality of elastic wave signals is less than a preset energy sum threshold;
condition 9: all energy mean values of the plurality of elastic wave signals in a first frequency band are greater than all energy mean values of the plurality of elastic wave signals in a second frequency band, and a maximum value of frequency amplitudes of the first frequency band is greater than a maximum value of frequency amplitudes of the second frequency band.

20. The method according to claim 18, wherein,
performing the signal cross-correlation characteristic analysis on the plurality of elastic wave signals comprises one or more of the following ways:
way 1: analyzing a Pearson correlation coefficient of two adjacent elastic wave signals in at least one of a time domain or a frequency domain;
way 2: analyzing mutual information of the two adjacent elastic wave signals in at least one of the time domain or the frequency domain;
based on the ways of performing the signal cross-correlation characteristic analysis on the plurality of elastic wave signals, the signal cross-correlation characteristics being consistent with the signal characteristics corresponding to the continuous tapping actions means that the signal cross-correlation characteristics of the plurality of elastic wave signals satisfies one or more of following conditions:
condition 1: the Pearson correlation coefficient is greater than or equal to a preset coefficient value A, and 0.4≤A≤0.5;
condition 2: the mutual information is greater than 0.

21. A vehicle control apparatus, the vehicle control apparatus comprises:
a storage module configured to store computer program instructions executable on a processor;
a processing module configured to execute the computer program instructions to implement the method according to claim 1.
